(19) United States
(12) Patent Application Publication
(10) Pub. No.: US 2016/0248113 A1
(43) Pub. Date: Aug. 25, 2016

(54) Semi-Interpenetrating Network Method for Dimensionally Stabilizing Highly Charged Polyelectrolyte Membranes

(71) Applicant: The Board of Trustees of the Leland Stanford Junior University, Palo Alto, CA (US)

(72) Inventors: Steve S. He, San Jose, CA (US); Curtis W. Frank, Cupertino, CA (US); Alaina Strickler, Stanford, CA (US)

(21) Appl. No.: 15/048,206

(22) Filed: Feb. 19, 2016

Related U.S. Application Data
(60) Provisional application No. 62/118,799, filed on Feb. 20, 2015.

(51) Int. Cl. H01M 8/1023; B01J 41/14; H01M 8/1032; B01J 41/12

(52) U.S. Cl. CPC H01M 8/1023; B01J 41/125; B01J 41/14; H01M 8/1032; H01M 2008/1095

(57) ABSTRACT

An anion transport membrane is provided, which is based on a linear polymer electrolyte with anion-exchange groups that mechanically reinforced by a covalently cross-linked network. The linear polymer electrolyte is partially or fully miscible with the second covalently cross-linked network. In another example, an anion transport membrane is provided, which is based on a linear quaternary ammonium polysulfone membrane backbone mechanically reinforced by a chemically-crosslinked network of poly(styrene-co-divinylbenzene), whereby the reinforcing network has covalent divinylbenzene cross-links.

### CROSS-REFERENCE TO RELATED APPLICATIONS

This application claims priority from U.S. Provisional Patent Application 62/118,799 filed Feb. 20, 2015, which is incorporated herein by reference.

### FIELD OF THE INVENTION

This invention relates to polyelectrolyte membranes for fuel cells and batteries.

### BACKGROUND OF THE INVENTION

Polymer electrolyte membrane fuel cells promise clean, scalable energy generation. In particular, current commercial implementations often use proton exchange membranes (PEMs) that operate by shuttling protons between electrodes. However, as a consequence of high proton concentrations, these devices operate in an extremely acidic environment in which only precious metal catalysts such as platinum are stable. Hence, the long-term commercial viability for PEM fuel cells is severely hindered by high catalyst costs. An alternative approach is to transport hydroxide ions using an Anion Exchange Membrane (AEM), resulting in a basic operating environment in which earth-abundant catalysts (e.g., manganese and nickel) are stable.

Unfortunately, typical AEM fuel cells perform markedly worse than their PEM counterparts. This performance gap is especially notable when comparing against PEM fuel cells based on Nafion, the de facto standard PEM material. The unfavorable performance of AEM fuel cells can be partially attributed to the lower ionic conductivities of typical AEM materials, which are often several times lower than those of Nafion and other PEMs. Attempts to resolve the performance issue typically focus on either modifying the chemistry of the pendant cation or changing the identity of the polymer backbone. For example, by replacing the typical quaternary ammonium cation with a more basic quaternary phosphonium cation, some were able to increase room-temperature conductivities from around 10 mS/cm to 38 mS/cm. More recent reports have begun to focus on achieving a more efficient ion transport architecture for hydroxide transport. Others have shown that using a quaternary ammonium cation with a short (8-16 carbon) aliphatic chain prompts microphase separation and higher performance. It has been reported that grafting linear aliphatic chains along the main polymer backbone promotes hydrophobic clustering, resulting in the creation of an ion transport “highway” in the interstitial, water-rich regions. Moreover, we recently reported that grafting poly(ethylene glycol) chains onto quaternary ammonium polysulfone results in nanophase separation between the hydrophilic grafts and the hydrophobic polymer backbone, producing water-rich ion transport channels and, consequently, higher ion transport efficiency.

The dilute solution mobility of the hydroxide anion is only 57% of that of the proton. Hence, to first approximation, for a given polymer system the hydroxide concentration must be roughly 1.8 times greater than the proton concentration to yield similar conductivities. This effect is evident from the literature, where many high-performing AEMs must have ion exchange capacities much higher than Nafion's to achieve similar performance. Of course, one might imagine that increasing the Ion Exchange Capacity (IEC) even further could lead to even higher performance; however, the higher ion content typically leads to increased water uptake and swelling, yielding diminishing returns on effective ion concentration as a result of dilution. Moreover, at excessively high IECs, the membranes simply lose mechanical integrity and rupture from the uptake of too much water. The present invention advances the art of polyelectrolyte membranes for alkaline fuel cells and polymer batteries.

### SUMMARY OF THE INVENTION

Polyelectrolyte membranes are critical for polymer batteries and fuel cells. Increasing the charge content of polyelectrolyte membranes can lead to higher performance at the cost of lowered dimensional stability. The invention here provides a facile method for mechanically strengthening highly-charged polyelectrolyte materials by introducing a cross-linked polystyrene-co-divinylbenzene network, allowing for both high performance and excellent mechanical stability. In one embodiment, we were able to increase the Young modulus of a highly-charged anion exchange membrane by two orders of magnitude (3.5 MPa to 100 MPa, hydrated). Concomitant with this increase is higher dimensional and conductivity stability; the unmodified membrane showed nearly 1600% water uptake at 50° C. prior to rupturing, while the semi-interpenetrating network (semi-IPN) membrane showed only 75% uptake and maintained mechanical integrity up to 80° C.

Polyelectrolyte materials are used for various applications, including water-filtration membranes and selective ion-transport membranes for batteries and fuel cells. The performances (as manifest in the ionic conductivities) of these materials are a function of their charge density or ion exchange capacity (IEC); however, increasing the charge density also leads to excessive water uptake and swelling, leaving behind an extremely fragile material that becomes unsuitable for commercial use. This invention provides a solution for this optimization problem. Specifically, the invention is a platform/method for modifying highly charged aromatic polyelectrolyte membranes to the end effect of significantly increasing dimensional stability without compromising ion transport performance.

The method as described is a facile way to mechanically strengthen existing polyelectrolyte materials, provided that the materials have a polymer backbone with sufficiently similar solubility parameters (namely, polymers that primarily have aromatic groups). We have shown the effectiveness of this approach by using linear quaternary ammonium polysulfone (QA PSf) as a benchmark material. We were able to significantly increase the dimensional stability of a highly-charged quaternized ammonium polysulfone (QA PSf) membrane which, in its base form, is unstable in water, even at room temperature; soaking in water resulted in complete dissolution of the membrane due to excessive swelling induced by high water uptake. Moreover, even at a lower charge the QA PSf membrane exhibited extremely high water uptake and swelling (400% water uptake by mass at room temperature); this became exacerbated at higher temperatures, reaching up to around 1600% water uptake by mass around 50° C. before rupturing. Following our method, we were able to create a semi-IPN to strengthen this unstable material, allowing us to reduce the water uptake to around 80% at room temperature; moreover, we found that this semi-IPN architecture was stable even at 80° C., showing only roughly 100% water uptake. Likewise, mechanical testing revealed that we were able to increase the hydrated elastic modulus by two orders of magnitude, from ca. 3.5 MPa to ca. 100 MPa upon creating the semi-IPN network. More information on the effectiveness of this approach can be found in the attached manuscript.

Furthermore, in another embodiment an alternate method is provided of achieving the same semi-IPN architecture, which may be more applicable, depending on the synthesis of the linear polymer portion. Namely, rather than swelling a preformed membrane in a monomer solution and photopolymerizing, we were able to mix the linear polymer with the monomers in a homogeneous solution along with a thermal initiator (azoisobutyronitrile) and cross-linker and polymerize the added monomer into a cross-linked network while casting the membrane itself. This approach has the benefit of a one-pot synthesis approach, cutting down on processing time. Moreover, it provides more compositional control as we can exactly control the mass percentage of each component (monomers and linear polymer); in contrast, the photopolymerization approach relies on thermodynamic swelling equilibrium of the system to establish the mass percentage.

In one embodiment, an anion transport membrane is provided, which is based on a linear polymer electrolyte with anion-exchange groups that are mechanically reinforced by a covalently cross-linked network. The linear polymer electrolyte is partially or fully miscible with the covalently cross-linked network. Examples of the linear polymer electrolyte are an aromatic polymer, an poly(phenylene oxide), a polyaryletherketone, a polybenzimidazole or an aromatic polysulfone. Examples of an anion-exchange group is ammonium, phosphonium, imidazolium, sulfonium, ruthenium, or guanidinium.

In another embodiment, an anion transport membrane is provided, which is based on a linear quaternary ammonium polysulfone membrane backbone (e.g. benzyltrimethylammonium polysulfone membrane backbone) mechanically reinforced by a chemically-crosslinked network of poly(styrene-co-divinylbenzene), whereby the reinforcing network has covalent divinylbenzene cross-links.

### BRIEF DESCRIPTION OF THE DRAWINGS

FIG. 1 shows according to an exemplary embodiment of the invention an illustration of semi-IPN Anion Exchange Membrane (AEM). Lines 110 represent quaternary ammonium polysulfone, lines 120 represent poly(styrene-co-divinylbenzene), and hexagons represent covalent divinylbenzene cross-links.

FIG. 2 shows according to an exemplary embodiment of the invention a differential TGA plot of polymerized monomer soaking solutions.

FIG. 3 shows according to an exemplary embodiment of the invention a differential TGA plot of QA PSf-226, QA sIPN-100/0 and QA sIPN-70/30 alkaline exchange membranes.

FIG. 4 shows according to an exemplary embodiment of the invention, on the left axis (bars), gravimetric monomer uptake of the CMPSf films after soaking in styrene/divinylbenzene monomer/cross-linker solution for 24 hours, and on the right axis (squares), theoretical Ion Exchange Capacity (IEC) as calculated by the monomer mass uptake based on the maximum IEC of 2.99 mEq/g for unmodified QA PSf-299.

FIG. 5 shows according to an exemplary embodiment of the invention gravimetric water uptake as a function of temperature.

FIG. 6 shows according to an exemplary embodiment of the invention thickness swelling of membranes at equilibrium water uptake at different temperatures.

FIG. 7 shows according to an exemplary embodiment of the invention temperature response of water uptake as normalized against the room temperature hydrated mass.

FIG. 8 shows according to an exemplary embodiment of the invention water uptake kinetics for the AEMs.

FIG. 9 shows according to an exemplary embodiment of the invention water uptake kinetics for the AEMs plotted according to the Schott second-order kinetics model. The dashed lines represent linear fits, showing excellent agreement to the Schott model. The water uptake here is defined as a ratio (g_{water} g_{polymer}⁻¹) instead of a percentage to facilitate calculation of the intrinsic rate constant.

FIG. 10 shows according to an exemplary embodiment of the invention in-plane hydroxide conductivity as a function of temperature (100% RH). Dashed lines are for guiding the eye.

FIG. 11 shows according to an exemplary embodiment of the invention Arrhenius plot of hydroxide conductivity at 100% RH. Dashed lines represent Arrhenius fit in the temperature range where Arrhenius scaling is observed.

FIG. 12 shows according to an exemplary embodiment of the invention alkaline stability of QA PSf-226 and QA sIPN-70/30 in 6M KOH solution at 40° C.

FIG. 13 shows according to an exemplary embodiment of the invention polarization (left axis, open markers) and power density (right axis, filled markers) for QA PSf-226 and QA sIPN-70/30 based MEAs at 35° C. and 80° C. at 100% RH. Back pressure is set to 200 kPa absolute.

FIG. 14 shows according to an exemplary embodiment of the invention ¹H NMR of chloromethylated polysulfone with DS 1.8.

FIG. 15 shows according to an exemplary embodiment of the invention ¹ H NMR of chloromethylated polysulfone with DS 1.25.

FIG. 16 shows according to an exemplary embodiment of the invention representative stress-strain curve for QA Semi-Interpenetrating Network (sIPN) membranes.

FIG. 17 shows according to an exemplary embodiment of the invention representative stress-strain curves for QA PSf-226 in dry and hydrated (inset) forms.

FIG. 18 shows according to an exemplary embodiment of the invention SAXS data for the alkaline exchange membranes.

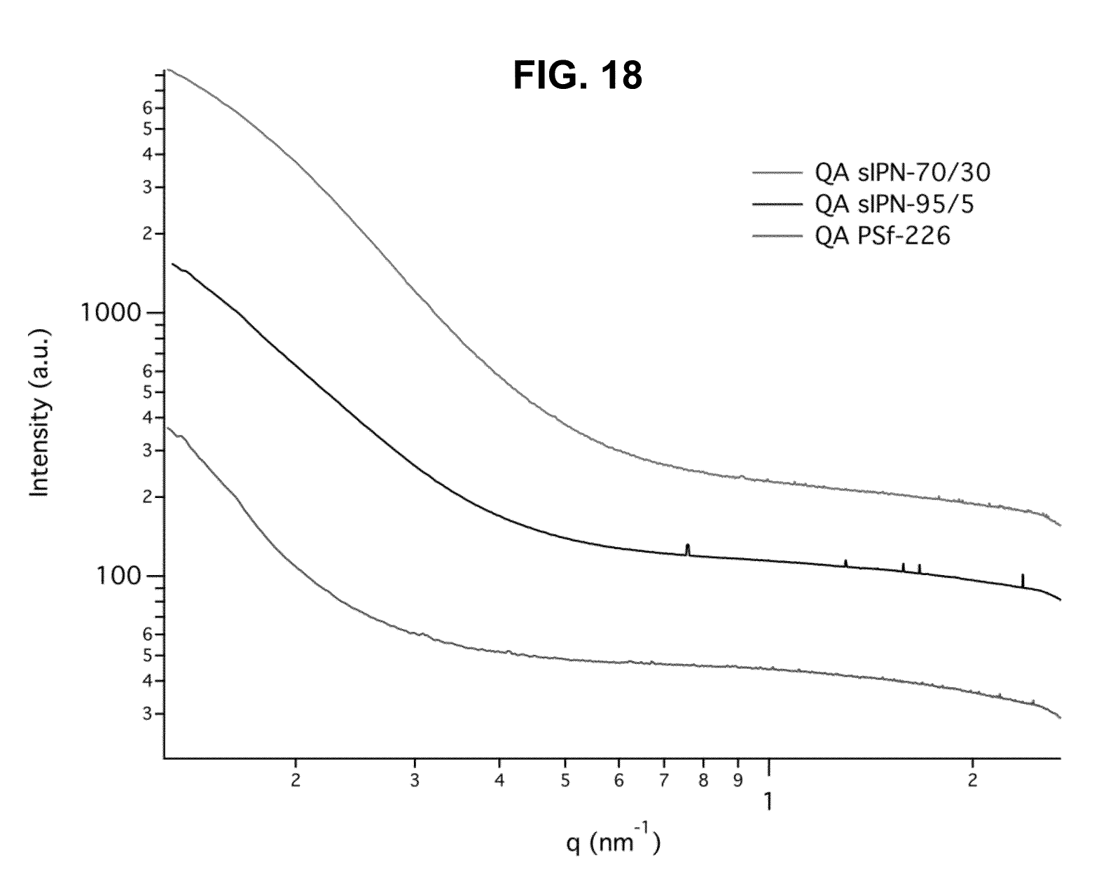

### DETAILED DESCRIPTION

In this invention, we describe the ability to significantly reduce water swelling and enhance the mechanical strength of highly charged anion exchange membranes by reinforcing the linear polyelectrolyte chains with a cross-linked matrix of a robust hydrophobic material, poly(styrene-co-divinylbenzene), essentially creating a semi-interpenetrating network (semi-IPN). A semi-IPN is defined as a system in which a linear polymer is homogeneously dispersed (at least on the length-scale of the polymer chains) within a covalently cross-linked polymer network; semi-IPNs have been reported previously in the fuel cell literature for enhancing the methanol resistance of Nafion and other PEMs.

The approach we provide here is applicable to a variety of anion exchange membranes, provided that the polyelectrolyte backbone has suitable compatibility with styrene and divinylbenzene. Specifically, we chose benzyltrimethylammonium polysulfone (QA PSf) as a benchmark material due to its ubiquity in the literature and incorporated a polystyrene (PS) or poly(styrene-co-divinylbenzene) (PS-co-DVB) network as a structural “scaffold” to limit swelling and enhance mechanical integrity. We found that films formed from a QA PSf material with an IEC of 2.99 mEq/g ruptured and solubilized in water, even under ambient temperatures; however, the addition of a secondary hydrophobic polymer provided mechanical stability even up to 80° C., depending on composition. Furthermore, the presence of this secondary hydrophobic network did not greatly diminish the in-plane hydroxide conductivity. All membranes exhibited room-temperature hydroxide conductivities between 38 mS/cm and 50 mS/cm and showed similar Arrhenius activation energies, suggesting that the semi-IPN structure did not introduce excessive tortuosity in the ion transport pathways of the conductive quaternary ammonium polysulfone.

### Synthesis and Characterization of Semi-IPN Membranes

Detailed synthesis and characterization methods can be found in the Experimental section. Benchmark benzyltrimethylammonium polysulfone membranes QA PSf-299 (IEC=2.99 mEq/g) and QA PS226 (IEC=2.26 mEq/g) were prepared by quaternization of chloromethylated polysulfone (CMPSf) with trimethylamine and solvent casting onto a glass slide.

The same CMPSf used for QA PS299 formed the basis for the semi-IPN membranes, which were prepared by swelling CMPSf films in a solution of styrene, divinylbenzene (DVB), and 2-hydroxy-2-methylpropiophenone (HMPP) photoinitiator. The compositions of the monomer soaking solutions are presented in TABLE 1. The monomer-swollen membrane was then subjected to UV irradiation (365 nm) to promote photopolymerization. The films were finally soaked in a trimethylamine/ethanol solution to convert the labile chloromethyl groups into quaternary ammonium moieties.

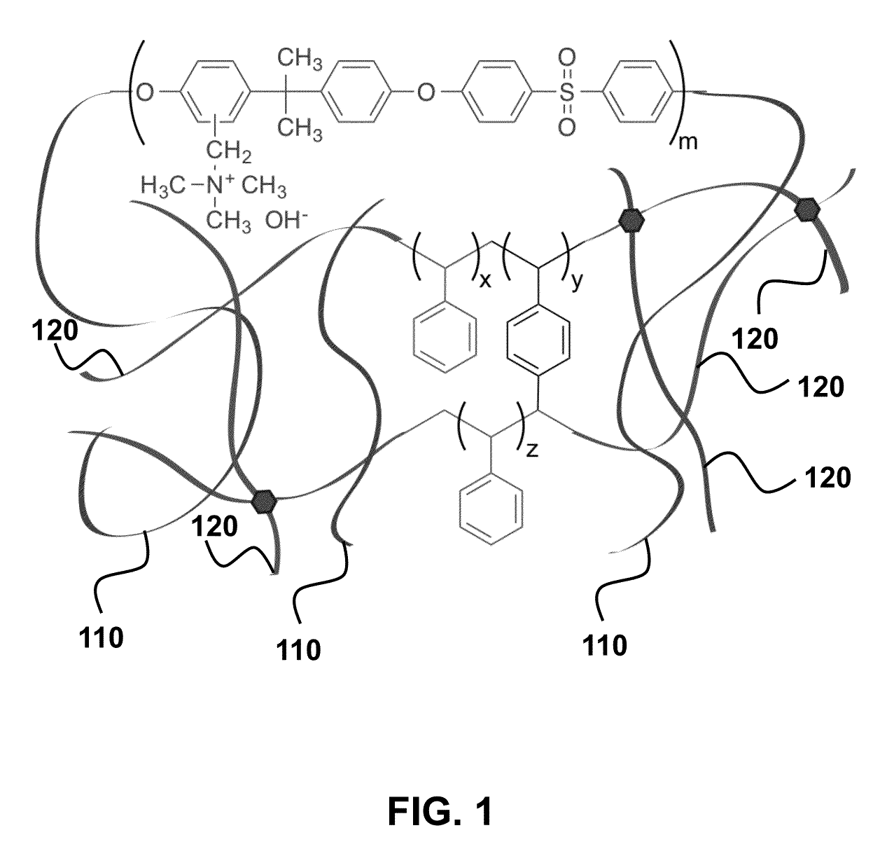

An illustration of a semi-IPN AEM prepared by this method is presented in FIG. 1. The semi-IPN membranes are denoted as QA sIPN-X/Y, where ‘X’ and ‘Y’ denote the volume percent of styrene and divinylbenzene, respectively, of the monomer soaking solution from which they were prepared. Note that QA sIPN-100/0 is, in a strict sense, a polymer blend and not a semi-interpenetrating network as there are no covalent cross-links; we chose this nomenclature for the sake of consistency.

TABLE 1
Composition of Monomer Soaking Solutions

| Sample | Styrene [mL] | Divinylbenzene [mL] | HMPP [uL] |
|---|---|---|---|
| QA sIPN-100/0 | 5.00 | 0.00 | 200 |
| QA sIPN-95/5 | 4.75 | 0.25 | 200 |
| QA sIPN-80/20 | 4.00 | 1.00 | 200 |
| QA sIPN-70/30 | 3.50 | 1.50 | 200 |

Polymerized films of the monomer soaking solutions were prepared and subjected to TGA to verify that inhibitors had been successfully removed and to characterize the degradation temperatures for polystyrene and poly(styrene-co-divinylbenzene).

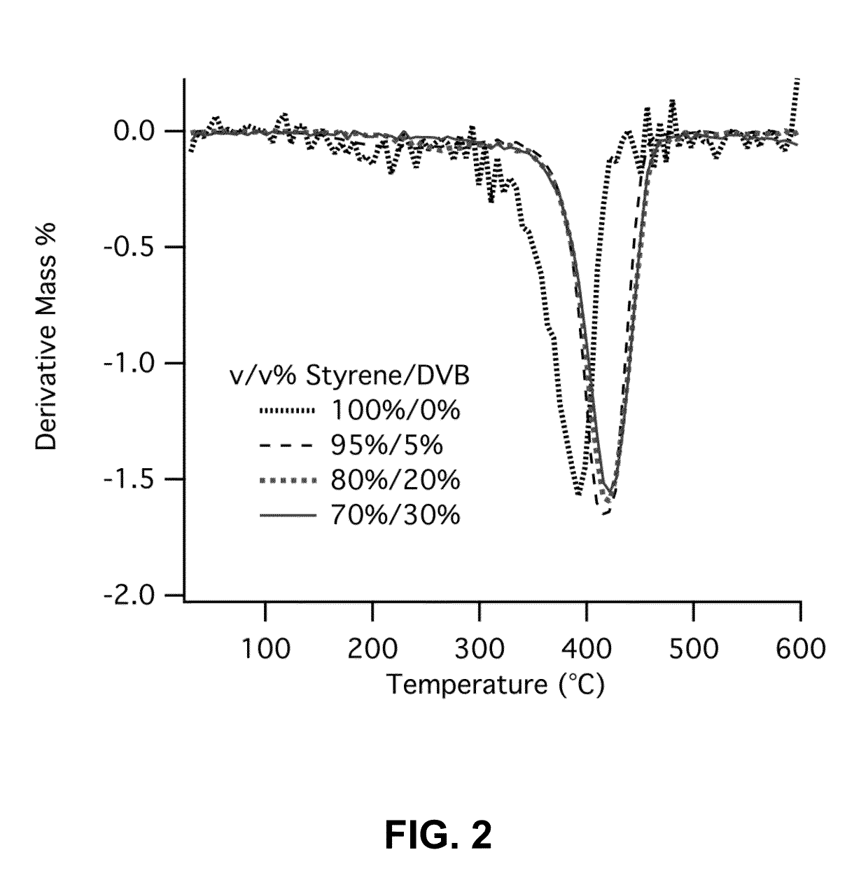

A differential TGA (dTGA) plot of the polymerized soaking solutions (FIG. 2) shows a mass loss peak in the 390° C. to 430° C. range, corresponding to the degradation of polystyrene and/or poly(styrene-co-divinylbenzene). Moreover, because styrene and divinylbenzene have boiling points of 145° C. and 195° C., respectively, the lack of mass loss below 200° C. suggests complete polymerization of the monomers. The sample resulting from polymerization of the pure styrene solution, which contained no divinylbenzene cross-linking functionalities, showed a characteristic mass loss temperature of 391° C. The solutions that contained DVB all show a notable upshift in the degradation temperature to the 410° C. to 430° C. range as a result of stabilization by the covalent cross-linking. Increasing the degree of cross-linking by increasing the proportion of DVB-to-styrene further raises the degradation temperature. The 95%/5% styrene/divinylbenzene solution showed a characteristic degradation temperature around 415° C. This shifts to 421° C. for the 80%/20% solution and to 425° C. for the 70%/30% solution as the higher DVB concentration leads to a greater extent of cross-linking. These data are consistent with literature on the thermal stability of polystyrene-divinylbenzene copolymers.

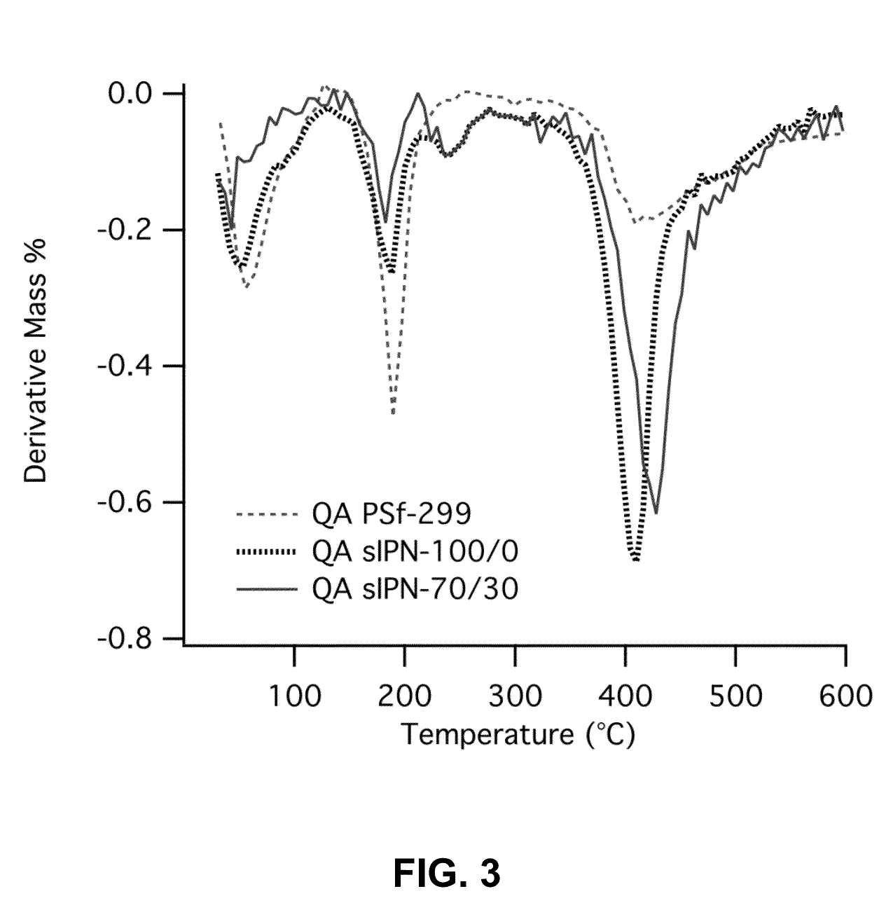

A similar characterization was carried out for the membranes, where dTGA data for the semi-IPN films were compared with the unmodified QA PSf-299 membrane to confirm successful polymerization of the styrene and DVB monomers within QA PSf-299 (FIG. 3). All membranes share a mass loss below 100° C. as a result of losing residual water and around 180° C. due to decomposition of the benzyltrimethylammonium sidegroups. The unmodified QA PSf-299 sample shows a broad mass loss above 350° C., which is ascribed to thermal decomposition of polysulfone. In comparison, QA sIPN-100/0 exhibits a sharp mass loss at a characteristic degradation temperature of 410° C., attributed to the presence of the polystyrene; the higher apparent characteristic degradation temperature compared to pure or neat polystyrene (391° C. as reported in the previous paragraph) is due to overlap with the thermal degradation of the polysulfone. As with the dTGA of the bare solutions (FIG. 2), the introduction of divinylbenzene in QA sIPN-70/30 results in covalent cross-links and an upshift in the degradation temperature to 428° C. The presence and composition-dependent behavior of these mass loss peaks suggests successful polymerization of the styrene/DVB monomers within the QA PSf-299 membrane.

### Monomer Uptake and Ion Exchange Capacity

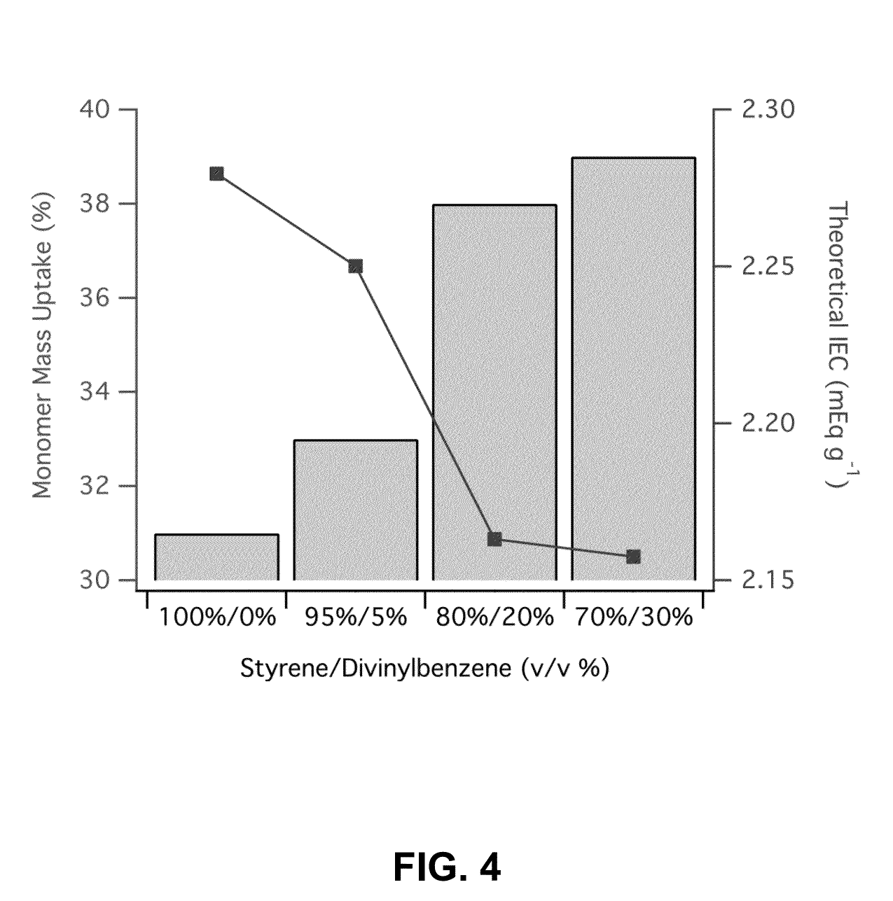

Poly(styrene-co-divinylbenzene) was chosen as the reinforcing matrix due to its excellent thermal, mechanical, and chemical robustness. Moreover, the structures of the styrene and divinylbenzene monomers are sufficiently similar to each other and to the polysulfone backbone to promote mixing between the various components. This property is manifest in their similar but not identical solubility parameters: polysulfone has a solubility parameter of 19.9 (J/cm³)^{1/2} while styrene and divinylbenzene have solubility parameters of 17.8 (J/cm³)^{1/2} and 17.4 (J/cm³)^{1/2}, respectively, as estimated by the Hansen group contribution method. At the same time, the difference in solubility parameter between polysulfone and styrene/divinylbenzene is sufficiently high enough to prevent complete dissolution of the membrane when placed in a monomer solution. Consequently, after soaking for 24 hours in a styrene and/or divinylbenzene solution, all CMPSf films showed monomer uptake ranging from 30% to 40% by mass (FIG. 4). Moreover, the swollen CMPSf films remained clear and colorless, suggesting there is no macroscale demixing and heterogeneity between the CMPSf and the styrene and/or divinylbenzene monomers.

Given the small difference in the solubility parameter between styrene and DVB, the increased gravimetric monomer uptake on increasing the concentration of DVB cannot be attributed to more preferable interaction between the polysulfone and DVB. Instead, the increased mass uptake is due to the higher molecular weight of DVB (130 g/mol) compared to styrene (104 g/mol). Assuming that the ratio of styrene to divinylbenzene in the film is equivalent to that of the swelling solution, all samples showed similar molar uptake (3.0 to 3.4 mmol per gram of CMPSf). Consequently, given the same initial theoretical IEC, the increased mass from monomer uptake leads to a decrease in the overall IEC of the membranes from 2.28 mEq/g in the QA sIPN-100/0 to 2.15 mEq/g in QA sIPN-70/30. In comparison, the unmodified QA PSf-299 and QA PSf-226 benchmark materials have theoretical IECs of 2.99 mEq/g and 2.26 mEq/g, respectively.

### Water Uptake and Temperature Stability

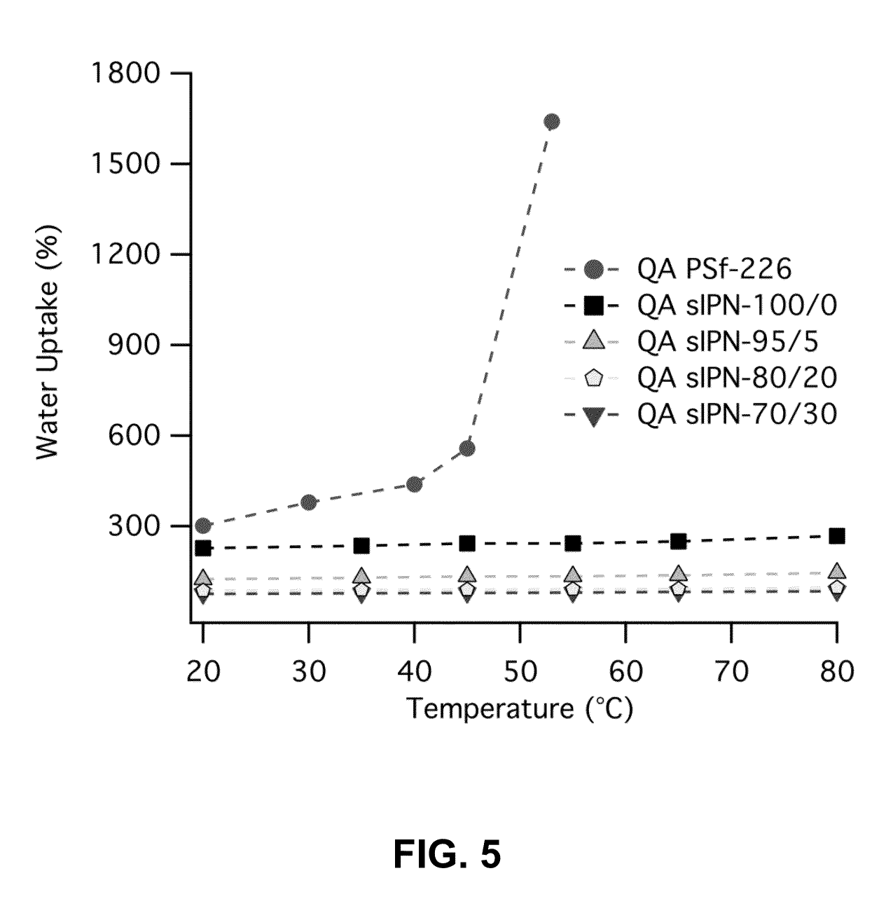

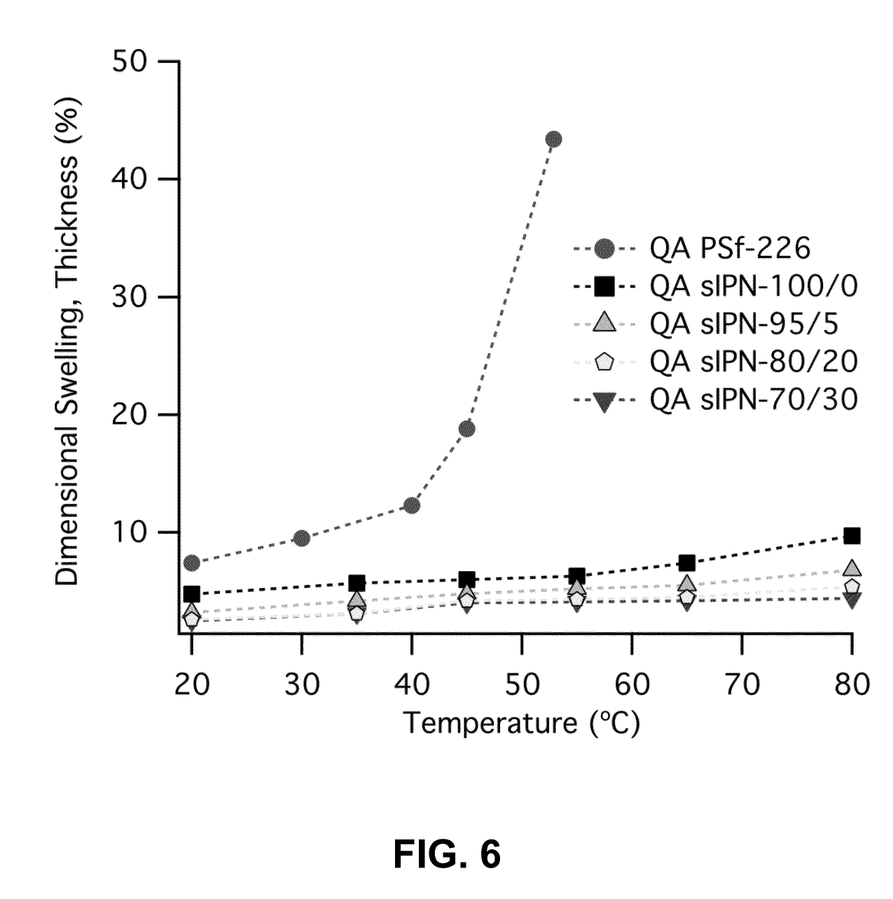

Increasing charge concentration (i.e., IEC) can potentially lower resistivity by introducing more free ions in the system. At the same time, however, the favorable solvation energy of ion pairs results in a significant increase in water uptake upon increasing the IEC, leading to excessive swelling, mechanical weakening, and eventual catastrophic rupturing of the membranes. Moreover, as water uptake typically scales disproportionately with increasing IEC, dilution effects begin to take place at higher charge contents. Our blend and semi-IPN membranes offer a solution to this issue, as the secondary hydrophobic component limits water uptake (FIG. 5) and constrains dimensional swelling (FIG. 6). The absence of data for the QA PSf-299 starting material is a result of complete mechanical failure and dissolution of the membrane in water, even at room temperature. In contrast, our modified membranes that incorporate the linear QA PSf-299 within either a polystyrene or poly(styrene-co-divinylbenzene) matrix remained as tough flexible films upon hydration, underscoring the effectiveness of this approach.

As a result of the instability of QA PSf-299, the lower IEC QA PSf-226 membrane was used as the primary benchmark; its 2.26 mEq/g IEC is in the vicinity of the blend and sIPN materials, which range from 2.28 mEq/g for QA sIPN-100/0 to 2.15 mEq/g for QA sIPN-70/30. We note that the introduction of a linear hydrophobic component (polystyrene) to create a blend results in a significant decrease in the water uptake, especially at higher temperatures. For example, the room temperature water uptake is reduced from 301% (QA PSf-226) to 227% (QA sIPN-100/0) despite both membranes having similar theoretical IECs (2.26 mEq/g and 2.28 mEq/g, respectively). More importantly, the QA PSf-226 benchmark completely ruptures above 50° C.; the membranes became extremely fragile around this temperature and often fractured when measuring their thickness. In contrast, QA sIPN-100/0 maintains its mechanical integrity even at 80° C. Introducing DVB crosslinks further reduces water uptake, where even a small amount of DVB content in QA sIPN-95/5 is able to substantially reduce the room temperature water uptake to 123%, roughly half of that of QA sIPN-100/0. This effect is enhanced at higher DVB contents where QA sIPN-70/30 exhibits 76% water uptake at room temperature, nearly a 4×decrease over the unmodified QA PSf-226 material.

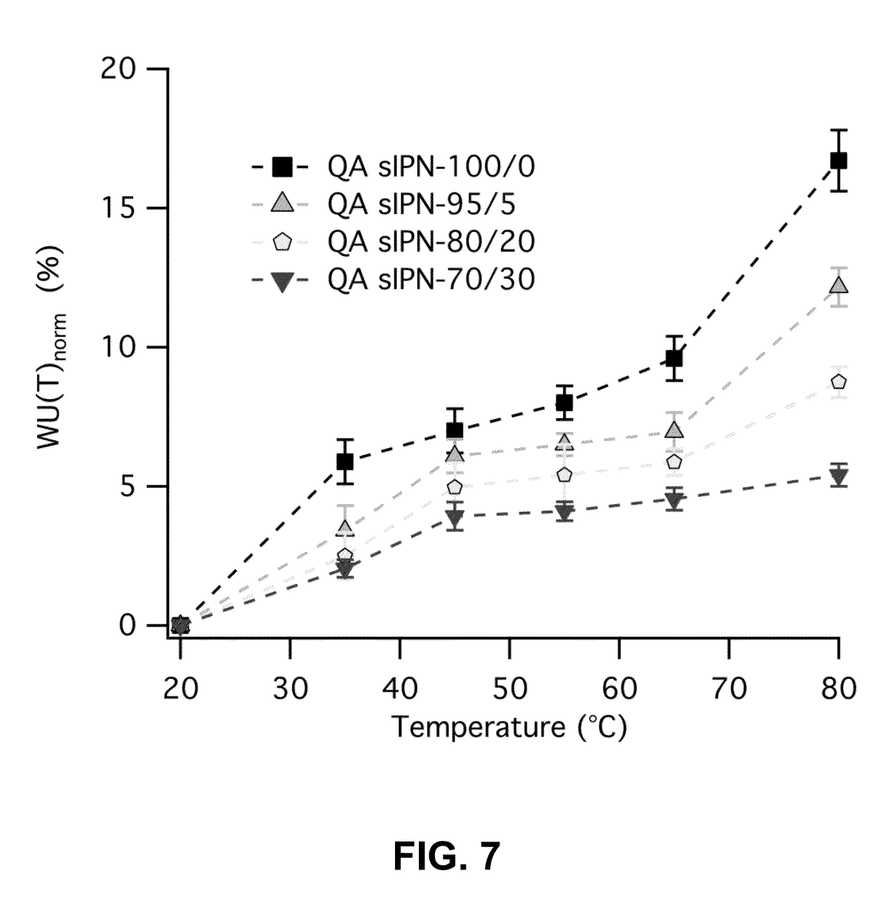

To better elucidate the effects of styrene and DVB content on the temperature dependence of water uptake, we define a normalized water uptake value

$${WU ( T )}_{norm} = 100 \frac{m ( T ) - m ( 20 ° C . )}{m ( 20 ° C . )} \qquad ( 1 )$$

where m(T) represents the hydrated mass at temperature T. This normalized value, WU(T)ₙₒᵣₘ, reflects the percent gain in mass of the fully hydrated sample at temperature T over its fully hydrated mass at room-temperature and better illustrates the temperature response in water uptake (FIG. 7).

The effect of temperature on water uptake, as shown in FIG. 7, can be categorized into three distinct temperature regimes: Region 1 between room temperature and 35° C. where there is a notable increase in the water uptake for all samples; Region 2, between 35° C. and 65° C., where the water uptake shows a limited dependence on the temperature, resulting in a plateaued temperature response; and finally Region 3, above 65° C., where the water uptake begins to again increase notably with increasing temperature.

The extent to which each membrane's water uptake thermally responds is highly dependent on composition. Our rationalization for the composition-dependent response in each of the regions, as well as for the shared features in the three regions, is based on the competition between the free energy associated with the osmotic pressure exerted by free ions within the membrane and the energy required to dimensionally swell the polymer matrix. The increase in water uptake between room temperature and 35° C. (Region 1) is attributed to a higher degree of ion solvation on increasing the temperature; the polymer matrix in this region is sufficiently compact such that the energy required to expand the matrix is lower than the energy gained from additional water incorporation. This idea is consistent with the composition dependence of the trend in water uptake, where membranes with a higher concentration of chemical crosslinks (inferred from the DVB content) show the lowest overall water uptake increase because the chemical cross-links inhibit chain mobility.

Following this rationale, the plateau in Region 2 is ascribed to finite extensibility of the polymer chains. The high extension of the polymers leads to a significant decrease in the number of accessible states, leading to large entropic losses; the energy required to strain the polymer network beyond a certain extension, therefore, becomes exponential with network strain. Consequently, the gravimetric water uptake exhibits minimal changes in this region as the energy released from additional water uptake is lower than that required to expand the polymer network.

In Region 3, all the samples, save for the highly cross-linked QA sIPN-70/30, exhibit a large deviation from this plateau behavior at temperatures above 65° C., resulting in escalated water uptake at higher temperatures. We suspect that this increase can be attributed to increased mobility of the polymer chains. Specifically, this thermal transition in the water uptake behavior coincides with the β transition temperature for atactic polystyrene (ca. 55° C. to 65° C.). This sub-T_{g} transition is a result of local reorientation and rotation of the phenyl rings, leading to overall conformational changes in the polystyrene backbone and, consequently, localized cooperative motion of the polystyrene chain. Hence, the β relaxation of the secondary polystyrene network, coupled with its thermodynamic mismatch with quaternary ammonium polysulfone, leads to chain migration and relaxation of the previously strained network, resulting in increased water uptake.

The extent of this effect is, as expected, diminished with increasing degree of chemical cross-linking, as highlighted by the fact that the highly cross-linked QA sIPN-70/30 sample did not exhibit a significant increase in water content at 80° C.

Thus, by introducing polystyrene and poly(styrene-co-divinylbenzene) networks, we were able to reinforce overall membrane structure, as exemplified by the decrease in gravimetric water uptake. Moreover, we note that the introduction of the DVB cross-links significantly limits membrane swelling at room temperature as well as water uptake at elevated temperatures.

### Swelling Kinetics

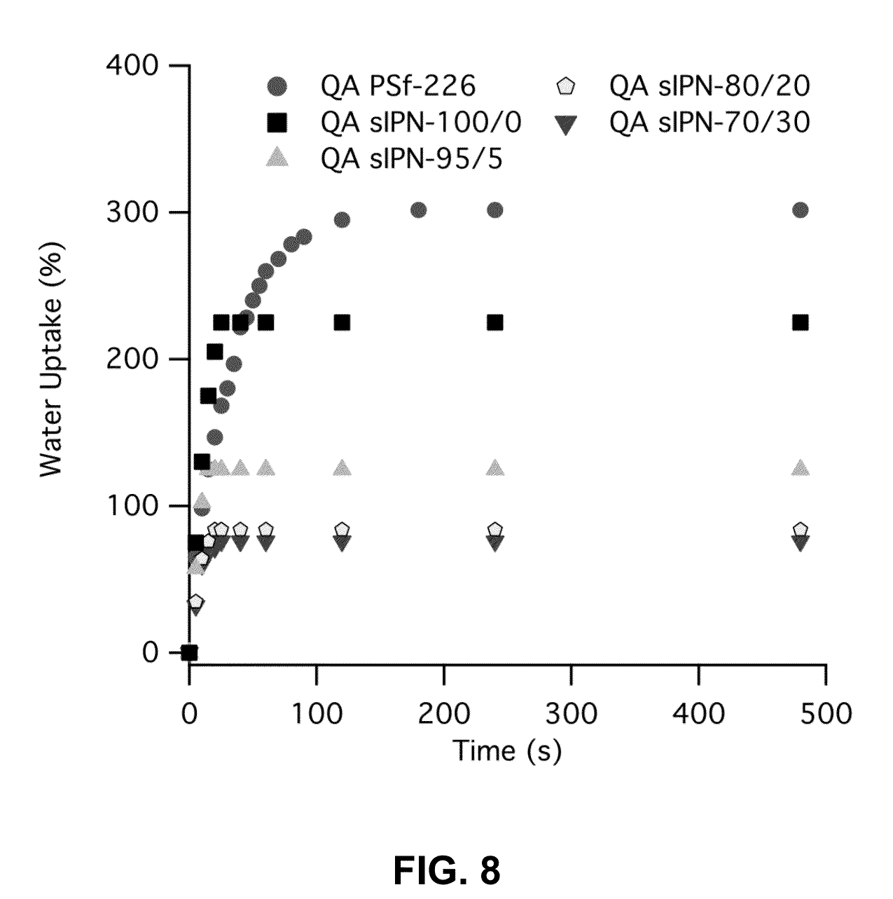

Time-dependent water uptake data revealed second-order uptake kinetics, where the initial high rate of swelling becomes increasingly retarded by chain stretching, asymptotically approaching equilibrium. Consequently, we employed Schott's model for second-order swelling kinetics to probe the effects of composition on the rate of water absorption within the films (FIG. 8). The Schott model explains the empirical second-order behavior by assuming that the observed swelling rate is directly proportional to the remaining swelling capacity. This is mathematically expressed as:

$$\frac{d W ( t )}{d t} = {K ( \frac{W ( ∞ ) - W ( t )}{W ( ∞ )} )}^{2} \qquad ( 2 )$$

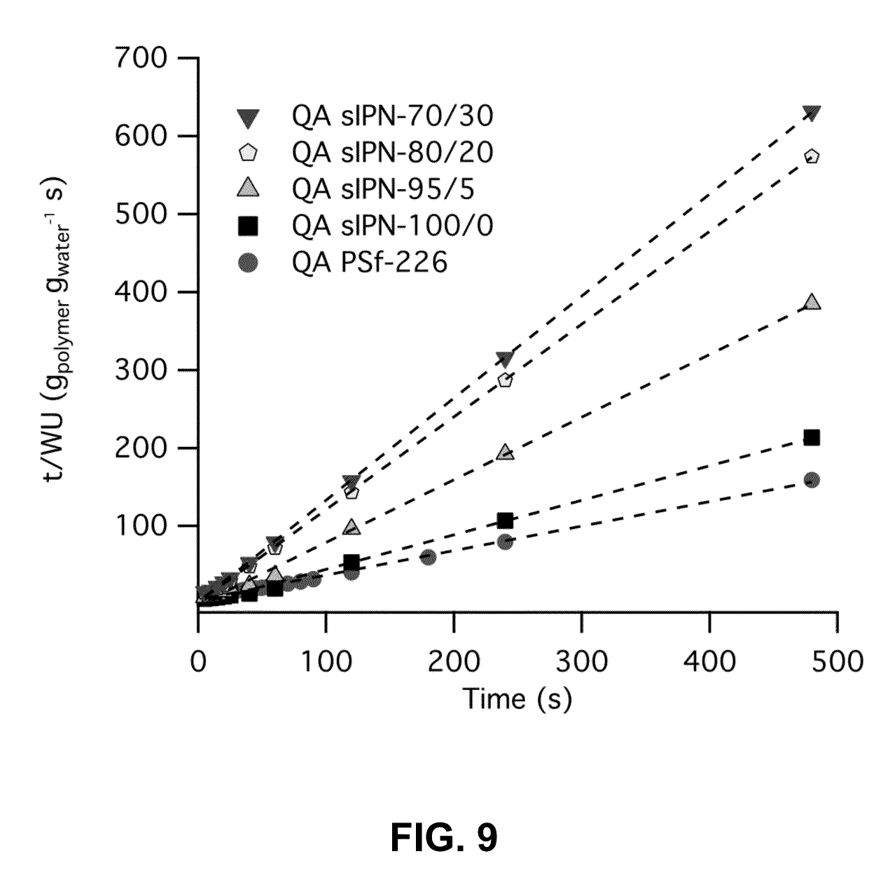

or, solving and rearranging, as:

$$\frac{t}{W ( t )} = \frac{1}{K \cdot {W ( ∞ )}^{2}} + \frac{t}{W ( ∞ )} \qquad ( 3 )$$

Where W(t), (W is also referred to herein as WU), is the water uptake at time t, W∞ is the water uptake at equilibrium, and K is the intrinsic rate constant for water swelling. Replotting the water uptake kinetic data in the form of Equation 3 shows excellent agreement with the Schott model (FIG. 9).

The intrinsic rate constants for water uptake in the different membranes were calculated from the intercept of the linear correlation and equilibrium water uptake (TABLE 2). We note that the unmodified QA PSf-226 membrane exhibited the lowest rate constant (0.02 g_{polymer} g_{water}⁻¹ S⁻¹). The incorporation of a hydrophobic polystyrene component (QA sIPN-100/0) increases the rate constant to 0.132 g_{polymer} g_{water}⁻¹ s⁻¹, while the addition of divinylbenzene cross-links further increases the rate constant to between 0.67 and 0.72 g_{polymer} g_{water}⁻¹. This trend is rationalized through composition-dependent chain relaxation processes, where QA PSf-226 shows the slowest water uptake rate as it is limited by the stress-relaxation kinetics of the linear polymer chains, an effect that is exacerbated by the large dimensional swelling of the film. Introducing a hydrophobic component reduces water uptake and consequently reduces strain, limiting the influence of stress-relaxation. Finally, covalent cross-linking constrains the overall system and inhibits segmental motion of the polymer chains, resulting in reduced swelling and a more elastic mechanical behavior; consequently, the water diffusion process becomes decoupled from the large-scale re-orientation of the polymer chains, leading to a high intrinsic rate of water uptake.

TABLE 2
Intrinsic rate constant for water uptake at 20° C.

| Sample | K [g_{polymer} g_{water}⁻¹ s⁻¹] |
|---|---|
| QA PSf-226 | 0.020 |
| QA sIPN-100/0 | 0.132 |
| QA sIPN-95/5 | 0.670 |
| QA sIPN-80/20 | 0.703 |
| QA sIPN-70/30 | 0.721 |

### Mechanical Properties

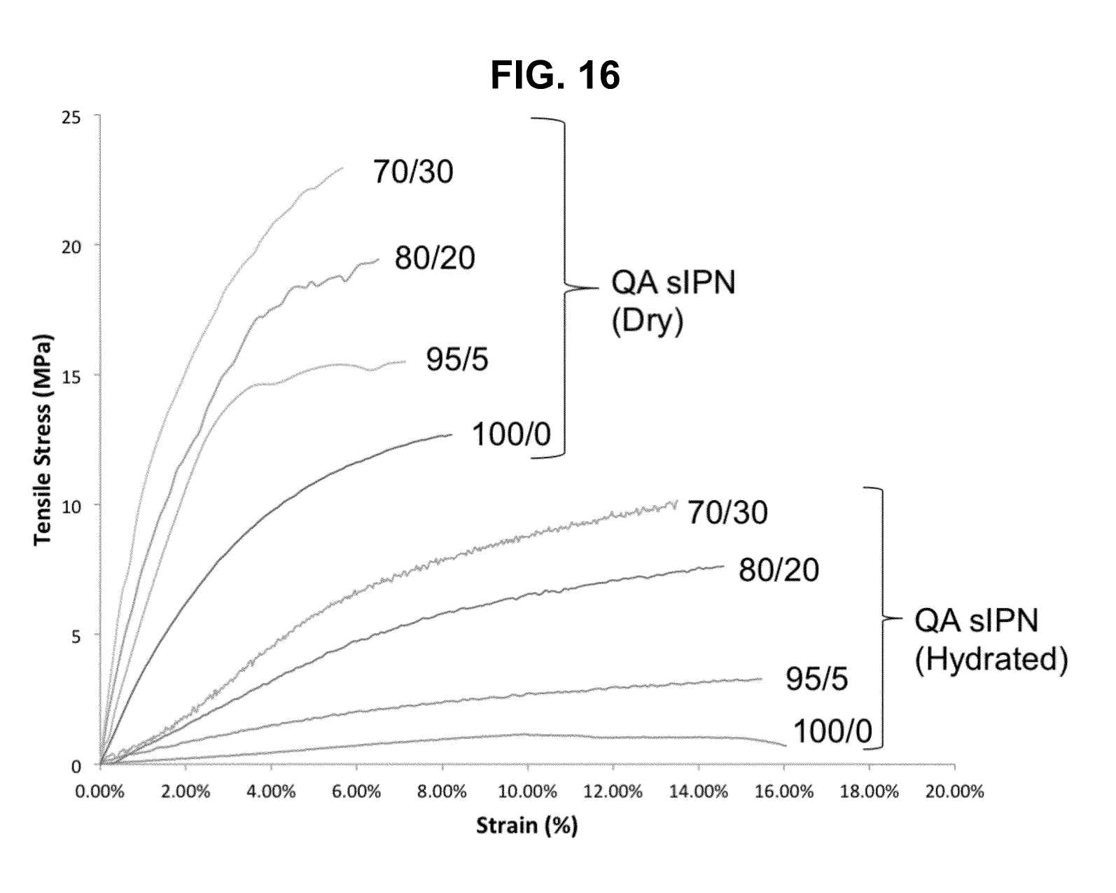

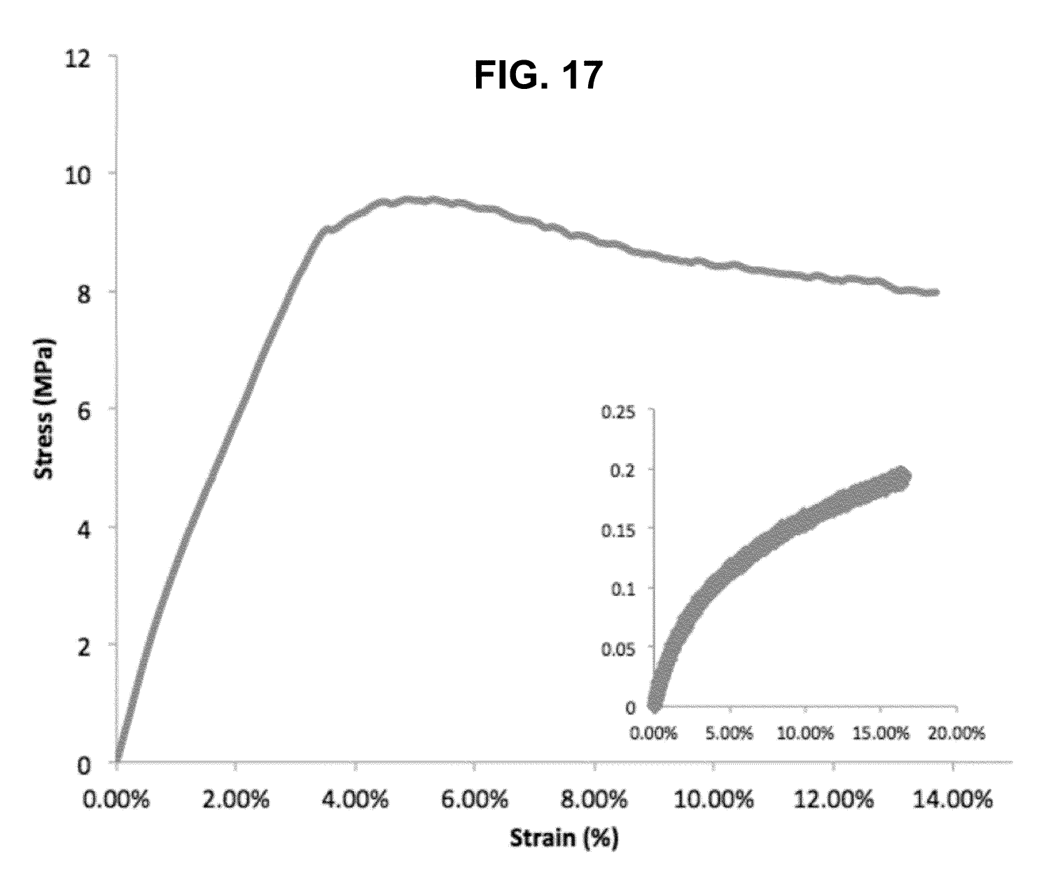

Pure polystyrene and poly(styrene-co-divinylbenzene) are brittle polymers with high elastic moduli and exhibit little plastic deformation. We performed tensile tests to explore how their incorporation in the semi-IPN architecture affects the mechanical properties of the ionomer membranes in both the dry and fully-hydrated states. Because the QA PSf-299 starting material was extremely delicate under these conditions, QA PSf-226 was again used for comparison. Representative stress-strain curves can be found in FIGS. 16 and 17.

TABLE 3
Mechanical properties of dry membranes (20° C. and 37% RH).

| | | | Max |
|---|---|---|---|
| Sample | Modulus [MPa] | Tensile Strength [MPa] | Strain [%] |
| QA PSf-226 | 277 ± 15 | 9.6 ± 1.2 | 9.5 ± 1.3 |
| QA sIPN-100/0 | 326 ± 23 | 13.2 ± 1.6 | 7.1 ± 2.2 |
| QA sIPN-95/5 | 401 ± 37 | 16.4 ± 2.8 | 6.7 ± 1.3 |
| QA sIPN-80/20 | 783 ± 27 | 18.8 ± 1.3 | 6.3 ± 1.1 |
| QA sIPN-70/30 | 1243 ± 42 | 21.2 ± 1.9 | 5.4 ± 0.8 |

The mechanical properties of the dry membranes were determined after equilibration with the ambient environment (20° C., 37% RH); characterization was performed under the same conditions and the results are presented in TABLE 3. The introduction of PS or a PS-co-DVB network results in increased elastic modulus and tensile strength compared to a linear QA PSf-226 membrane of similar IEC. As hinted at by the water-uptake kinetics discussed supra, the stress-strain curves of the semi-IPN membranes (FIG. 16) show a highly elastic response compared to the plastic behavior of the linear QA PSf-226 membrane. At higher DVB content there is a significant increase in both the modulus and the tensile strength as a result of more crosslinking, with QA sIPN-70/30 exhibiting an approximately 550% higher modulus and 100% higher tensile strength than QA PSf-226. At the same time, as a result of the brittle character of both PS and PS-co-DVB, the elongation at break of the semi-IPN membranes was roughly 50% to 60% of the linear QA PSf-226 membrane. The combination of these effects led to qualitatively stiff semi-IPN membranes in the dry state, breaking upon bending beyond ˜15°, however, they were nevertheless flexible enough to be mechanically stable under careful handling and were robust enough to be loaded into the tensile testing clamps without fracturing.

TABLE 4
Mechanical properties of hydrated membranes (20° C. in water bath).

| | | | Max |
|---|---|---|---|
| Sample | Modulus [MPa] | Tensile Strength [MPa] | Strain [%] |
| QA PSf-226 | 3.50 ± 0.32 | 0.20 ± 0.13 | 12.1 ± 6.3 |
| QA sIPN-100/0 | 10.1 ± 2.6 | 1.15 ± 0.29 | 14.5 ± 3.1 |
| QA sIPN-95/5 | 21.0 ± 2.8 | 3.81 ± 0.75 | 14.8 ± 2.6 |
| QA sIPN-80/20 | 73.8 ± 4.7 | 8.32 ± 0.93 | 13.6 ± 2.7 |
| QA sIPN-70/30 | 96.8 ± 8.5 | 10.2 ± 1.3 | 12.5 ± 1.9 |

Tensile tests of the hydrated membranes were performed inside a water bath at 20° C. (TABLE 4). Water-induced plasticization is a well-known phenomenon in polyelectrolyte membranes and is manifest here as an increase in the maximum strain and a decrease in the modulus and tensile strength across all samples upon hydration. Most notably, as a result of high water uptake (301%), the linear QA PSf-226 material was fragile with a tensile strength below 0.5 MPa and an elastic modulus of only 3.5 MPa. In comparison, the QA sIPN-70/30 material's modulus and tensile strength were nearly two orders of magnitude higher. Despite its relatively low strain-at-break, the ˜100 MPa modulus and ˜10 MPa strength of QA sIPN-70/30 are comparable to those of fully-hydrated Nafion 117 (114 MPa modulus and 14 MPa tensile strength).

We present a scaling analysis to illustrate the structure-property relationship in the cross-linked membranes. Intuitively, the elastic modulus should increase with a higher cross-link density and a lower degree of swelling. Accordingly, the elastic modulus, E, of the hydrated materials scales with ρₓ, the crosslink density, and Φₚ, the volume fraction of dry polymer at equilibrium swelling, as follows:

E·ρₓφₚ^{1/3} (4)

Assuming that the dry polymer has a similar mass density as water and that the ideal crosslink density scales directly with the volume fraction of divinylbenzene, we arrive at the following approximate scaling for the elastic modulus:

E^{ideal}˜φ_{DVB}Q^{-1/3} (5)

Where Φ_{DVB} is the volume fraction of DVB of the soaking solution and Q is the swelling ratio of the total hydrated mass to the dry mass of the material at equilibrium water uptake.

TABLE 5
Comparison between empirical and predicted elastic modulus of hydrated
semi-IPN materials.

| Sample | Φ_{DVB} | Q^{-1/3} | E [MPa] | E^{ideal} [MPa] |
|---|---|---|---|---|
| QA sIPN-95/5 | 0.05 | 0.765 | 21.0 ± 2.8 | — |
| QA sIPN-80/20 | 0.20 | 0.807 | 73.8 ± 4.7 | 88.6 |
| QA sIPN-70/30 | 0.30 | 0.830 | 96.8 ± 8.5 | 136.6 |

Using this scaling argument (Equation 5), we predicted the modulus for QA sIPN-80/20 and QA sIPN-70/30 based on the experimentally measured modulus for QA sIPN-95/5. TABLE 5 presents the comparison of the predicted modulus, which is based solely on ideal scaling with respect to DVB content and swelling ratio, to the empirical modulus as determined by tensile testing. The estimated elastic modulus based on this crude scaling analysis is close to the experimentally measured values, underscoring the idea that an increase in DVB content of the soaking solution directly contributes to a higher cross-linking density and enhanced mechanical properties.

### Hydroxide Conductivity

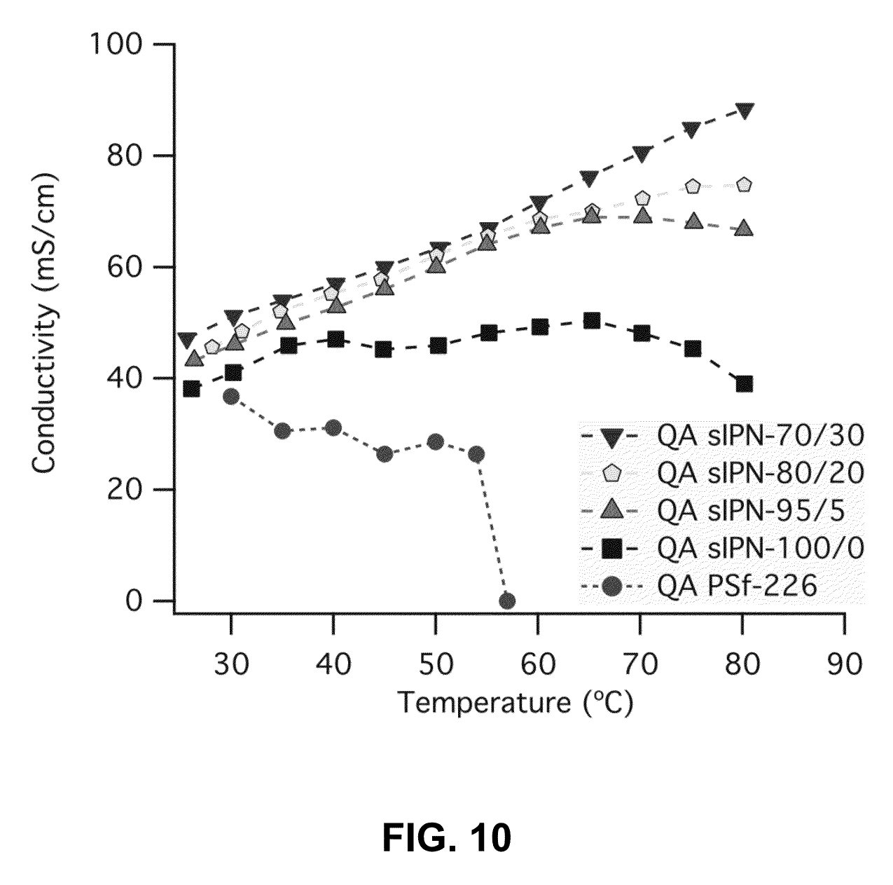

The in-plane hydroxide conductivities (σ) of the membranes as a function of temperature are shown in FIG. 10. Again, QA PSf-299 data could not be included due to dissolution at room temperature. To inhibit conversion of the hydroxide ions into carbonate/bicarbonate, all measurements were performed in an enclosed chamber under hydrated nitrogen gas flow.

The QA PSf-226 membrane measured a hydroxide conductivity of 38 mS/cm at 30° C., consistent with literature reports of QA PSf materials with similar IECs. However, the material exhibited extremely poor temperature response, showing a slight drop in the hydroxide conductivity as it was heated up to 55° C. This is attributed to the excessive water uptake and swelling of the membrane, which reaches over 400% at 40° C. and 1600% at 55° C. Indeed, raising the temperature above 55° C. resulted in rupturing of the membrane due to excessive water uptake.

In contrast, introducing a hydrophobic polystyrene component in QA sIPN-100/0 provides conductivity stability up to 65° C. by reducing swelling. Although the conductivity begins to drop after 65° C., the QA sIPN-100/0 membrane nonetheless remains mechanically stable and does not exhibit the catastrophic failure of QA PSf-226.

The introduction of DVB to form a cross-linked poly(styrene-co-divinylbenzene) matrix around the conductive quaternary ammonium polysulfone (creating a semi-IPN architecture) further enhances temperature stability, with QA PSf sIPN-80/20 and QA PSf sIPN-70/30 exhibiting stability even at 80° C. despite their high IECs. In particular, QA PSf sIPN-70/30 showed the greatest absolute conductivity, measuring 89 mS/cm at 80° C. Ultimately, the conductivity data verifies that the increased stability and decreased water uptake obtained through adoption of the semi-IPN architecture translates to improved performance and better thermal stability.

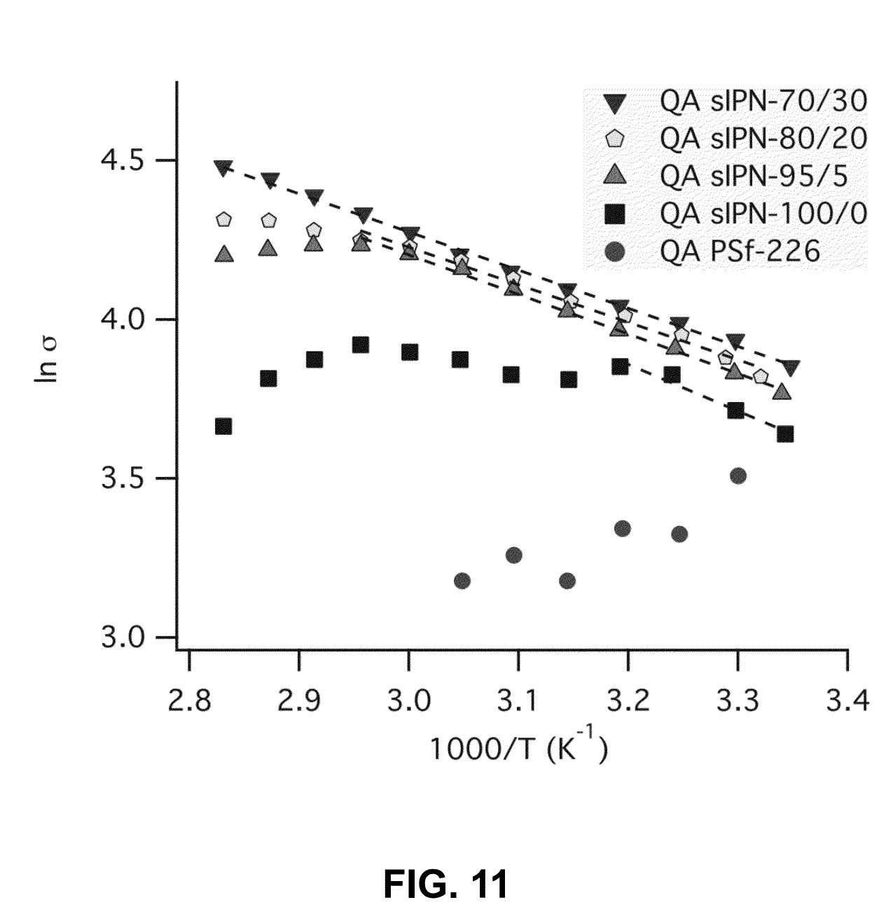

An Arrhenius plot of the conductivity-temperature relationship is shown in FIG. 11. Interestingly, deviation from Arrhenius behavior is correlated with the temperatures at which the water uptake exits the plateau region described previously. For example, QA sIPN-95/5 begins showing a decrease in conductivity after around 60° C. to 70° C., which corresponds to the temperature range in which the water uptake begins to sharply increase again (FIG. 7). We suspect that these two behaviors are intrinsically tied, wherein the proposed β relaxation of poly(styrene-co-divinylbenzene) leads to reorientation of the secondary network, consequently altering the ion transport morphology. We suspect that this chain migration, coupled with dilution of charges from increased water uptake, leads to the observed non-Arrhenius behavior. This effect is underscored by comparing the water uptake and conductivity behavior for QA sIPN-70/30, a sample in which the large degree of cross-linking inhibits migration of the poly(styrene-co-divinylbenzene) network. These cross-links lead to a continued plateau behavior in the water uptake at temperatures greater than 65° C. and a concomitant adherence to Arrhenius scaling of the conductivity.

We were initially concerned that the presence of a cross-linked secondary network may introduce increased tortuosity in the ion transport pathways, leading to lower ionic conductivities and a trade-off in mechanical stability versus performance. Unexpectedly, however, we found experimentally that was not the case, with all samples exhibiting similar room-temperature conductivities. The independence of room-temperature conductivity from both the presence and composition of the secondary network suggests that the hydrophobic reinforcing scaffold is sufficiently phase-separated from the hydrophilic ion transport domains as to not interfere with the ion transport mechanism. This is further evidenced in the fact that all semi-IPN membranes exhibit activation energies around 11 kJ/mol as calculated in the temperature regime where Arrhenius behavior is present, suggesting similar ion transport mechanisms. Moreover, these values for the activation energy are comparable to those for hydroxide transport in aqueous solution, again suggesting that the hydrophobic poly(styrene-co-divinylbenzene) network has little influence on ion transport morphology at the high IECs and water uptakes investigated here.

### Leaching and Alkaline Stability

The long-term stability of AEMs is critical to their device viability. Given that the linear ionomer component (i.e., QA PSf) within the semi-IPN membranes presented here is chemically decoupled from the cross-linked poly(styrene-co-divinylbenzene) matrix, gradual demixing and leaching out of the ionically conductive QA PSf component from the cross-linked PS-co-DVB network presents a valid concern. This concern is exacerbated by reports, which suggest that, upon cationic functionalization, the polysulfone backbone itself becomes vulnerable to nucleophilic attack; backbone cleavage would yield smaller fragments that would exhibit faster phase separation and migration from the cross-linked matrix.

To characterize the leaching stability, we monitored changes in both the mass and conductivity of the QA sIPN-70/30 membrane under prolonged conductivity testing at 40° C. and 100% RH (TABLE 6). Because the hydroxide anion is vulnerable to conversion to bicarbonate and carbonate, the membrane was kept in the chloride form for the long-term leaching test. Over the course of 20 days, we found negligible changes in either mass or conductivity, suggesting that leaching of the active QA PSf polyelectrolyte from the cross-linked PS-co-DVB matrix is insignificant during extended operation under aqueous conditions.

TABLE 6
Leaching Stability of QA sIPN-70/30 in Cl⁻ form.

| | 1 Day | 5 Days | 10 Days | 15 Days | 20 Days |
|---|---|---|---|---|---|
| % Initial Mass | 100% | 99.7% | 100% | 100% | 99.3% |
| % Initial σ | 99.0% | 97.8% | 97.1% | 98.5% | 97.6% |

Quaternary ammonium polysulfone is known to exhibit chemical and mechanical degradation when exposed to highly alkaline environments. For example, the pendant benzyltrimethylammonium cation is vulnerable to nucleophilic attack by hydroxide anions. Furthermore, reports have shown that the electron withdrawing effect of pendant cations makes the polysulfone backbone susceptible to hydrolytic cleavage, resulting in the loss of mechanical integrity.

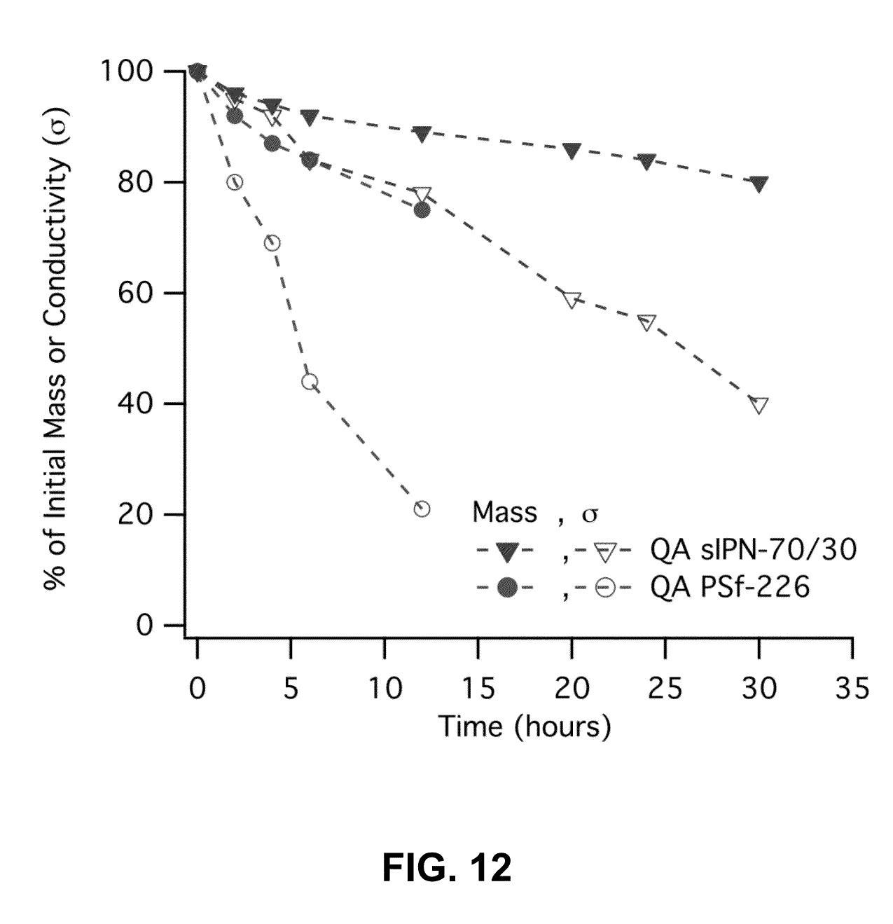

To investigate whether the semi-IPN structure had any influence on alkaline stability, we subjected both QA PSf-226 and QA sIPN-70/30 to accelerated degradation testing, monitoring changes in conductivity and mass after soaking in a highly alkaline (6M KOH) solution at 40° C. (FIG. 12). The QA PSf-226 membrane showed rapid loss in both conductivity and mass, becoming extremely fragile and exhibiting catastrophic mechanical failure within 12 hours of exposure, indicating significant degradation of the polymer backbone. On the other hand, the QA sIPN-70/30 sample showed enhanced mechanical integrity and was able to withstand exposure to the 6M KOH solution for 30 hours prior to brittle failure. A PS-co-DVB sample subjected to the same conditions showed no significant change in mass, suggesting suitable alkaline resistance. The ultimate stability enhancement is therefore ascribed to the presence of the PS-co-DVB matrix.

Despite the improvement, the overall system stability is fundamentally limited by the inherent issues of QA PSf described supra. A potential solution is to form a full IPN by cross-linking the QA PSf chains, partially mitigating the stability issues brought about by cleavage of the polysulfone. Moreover, while we used QA PSf as a benchmark to test our design, the synthesis is adaptable to other aromatic backbones (specifically those with similar solubility parameters) and/or other cation groups (provided the reagents are able to diffuse into and react within the semi-IPN film).

### Membrane Electrode Assembly Performance

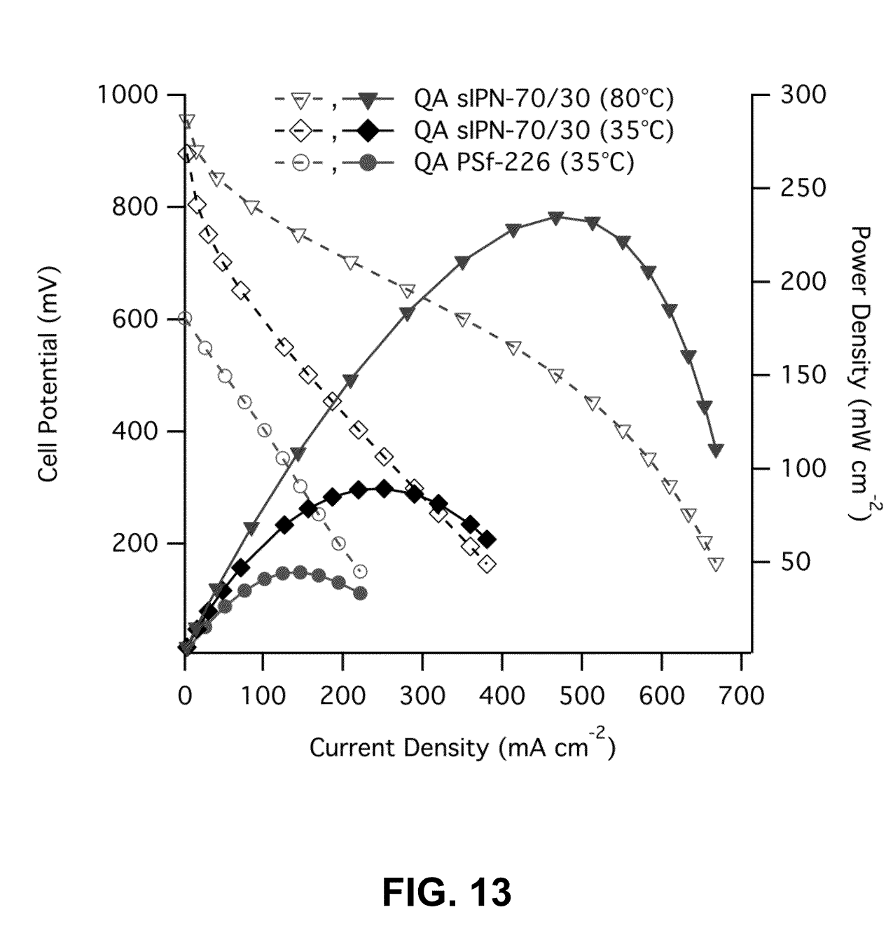

QA sIPN-70/30 was incorporated into a membrane electrode assembly (MEA) to assess device viability. FIG. 13 shows the polarization curve for both QA sIPN-70/30 at 35° C. and 80° C. and QA PSf-226 at 35° C. under H₂/O₂ flows. Note that the ˜40 mV difference in OCV between 35° C. and 80° C. for the QA sIPN-70/30 MEA is larger than would be expected from increased reaction kinetics alone. As we used the MEAs as-fabricated and without any additional activation protocol, we suspect that the load-cycling from the 35° C. measurement helped “break in” the MEA, resulting in better catalyst activity and a concomitant increase in the OCV when conducting the 80° C. measurement.

Qualitatively, we found that the high water uptake of the unreinforced QA PSf-226 baseline material rendered it mechanically delicate and prone to tearing during the fabrication of the MEA. This is reflected in the marked performance contrast between the QA sIPN-70/30 and the QA PSf-226 MEAs at 35° C., despite the two membranes exhibiting similar in-plane conductivities. Most notably, the open circuit voltage (OCV) for the QA PSf-226 membrane measured only ˜600 mV compared to ˜950 mV for the QA sIPN-70/30 membrane despite similar electrode materials, indicating significant fuel crossover effects that likely result from poor mechanical stability of the membrane (e.g., cracks and/or pinhole artifacts). This ultimately resulted in the baseline QA PSf-226 MEA exhibiting performance metrics (peak power density, maximum current density, etc.) that are roughly 50% of those of the more mechanically robust QA sIPN-70/30 MEA.

The poor mechanical stability of the QA PSf-226 membrane also led to an inability to test the MEA at higher temperatures; elevating the temperature past 40° C. resulted in a sharp drop in the OCV and failure of the device. In contrast, the QA sIPN-70/30 MEA was stable up to 80° C., yielding a maximum current density around 670 mA/cm² and a peak power density (PPD) of 236 mW/cm². These results confirm that our mechanical reinforcement of a high IEC, linear alkaline polyelectrolyte directly translates to better overall device stability and performance.

### CONCLUSIONS

We have demonstrated the ability to enhance the chemical and mechanical stability of a highly charged (IEC=2.99 mEq/g) benzyltrimethylammonium polysulfone (QA PSf-299) alkaline exchange membrane material by reinforcing the linear polyelectrolyte chains with a cross-linked poly(styrene-co-divinylbenzene) matrix, producing a semi-interpenetrating network architecture. Unlike the base QA PSf-299 material, which ruptured in water even at room temperature due to excessive water uptake, the semi-IPN membranes exhibited mechanical stability up to 80° C. even with a high IEC in the 2.20 to 2.30 mEq/g range.

The enhanced stability is attributed to a dramatically lower gravimetric water uptake and better mechanical properties. The higher dimensional stability of the semi-IPN membranes translated to better conductivity stability at higher temperatures. Moreover, the room-temperature conductivities for semi-IPN samples did not vary drastically with the composition of the poly(styrene-co-divinylbenzene) network, suggesting that this network did not interfere with the ion transport mechanics of QA PSf. This conclusion is underscored by the fact that all the semi-IPN membranes had similar Arrhenius activation energies. Finally, the highly charged semi-IPN membranes were stable up to 80° C. while operating in a membrane electrode assembly, with the QA sIPN-70/30 MEA exhibiting a peak power density (PPD) of 236 mW/cm² and a maximum current density around 670 mA/cm².

We found that the extra support provided by the cross-linked poly(styrene-co-divinylbenzene) matrix is able to nearly triple the lifespan of the membrane under accelerated degradation conditions (6M KOH, 40° C.), Importantly, the semi-IPN approach can easily be adapted to more stable AEM backbones such as poly(phenylene oxide) and/or more stable cations such as quaternary sulfonium and phosphonium. Ultimately, our results set a framework that can be applied to other chemically robust polyelectrolytes, such as for example a permutation of the backbone and anion exchange groups e.g., phosphonium-functionalized polysulfone, ammonium-functionalized poly(phenylene oxide), guanidinium-functionalized polysulfone. Another family of polymers that would be compatible with application of this invention would be the polyaryletherketone family that could include poly(ether ether ketone) (Victrex PEEK), poly(ether ketone) (Soway PEK), poly(ether ketone ketone) (DuPont Declar), poly(ether ether ketone ketone))PEEKK) and poly(ether ketone ether ketone ketone) (BASF PEKEKK). Similarly, poly(arylene thioether sulfone)s and copolymers with imide-forming sequences would be acceptable. In addition, poly(phenylene oxide)s would be appropriate for practice of this invention.

### Experimental Section

### Materials

Styrene and divinylbenzene monomers were purchased from Sigma Aldrich. The 4-tert-butylcatechol inhibitors were removed by passing the monomers through an alumina column prior to use. All other chemicals were used as purchased without further purification. Trimethylamine (4.2M in ethanol), chlorotrimethylsilane, paraformaldehyde, stannic chloride, and 2-hydroxy-2-methylpropiophenone were purchased from Sigma Aldrich. Udel P-3500 MB8 polysulfone was provided by Solvay Chemicals. Potassium hydroxide and all solvents (chloroform, ethanol, etc.) were purchased from Fisher Scientific.

### Synthesis

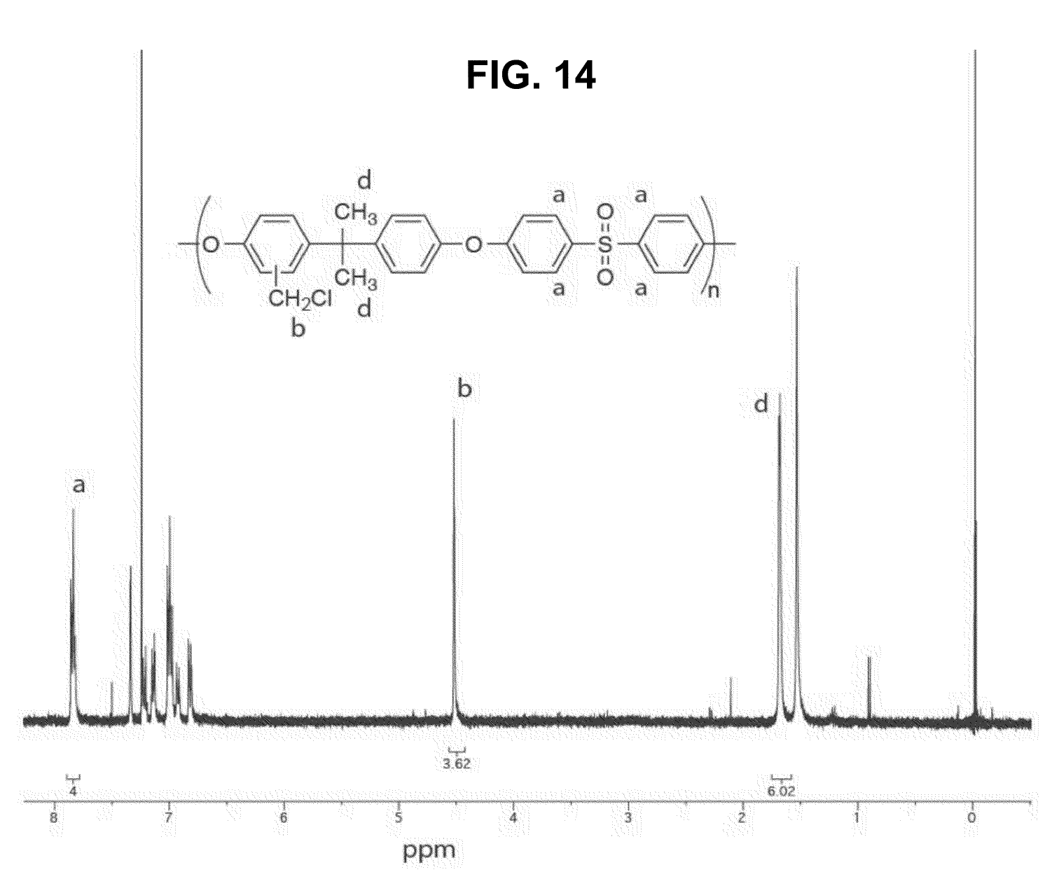

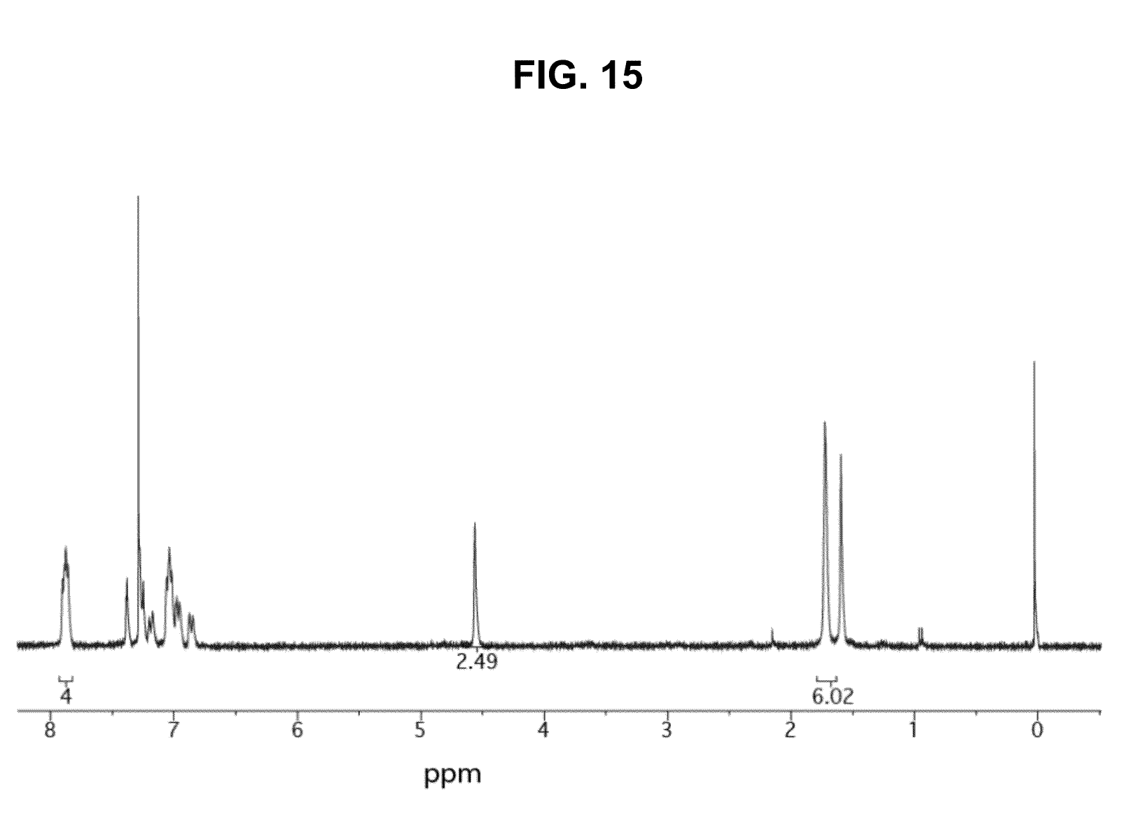

Chloromethylated polysulfone (CMPSf) was prepared and characterized at degrees of substitution (DS) of 1.8 and 1.25, where DS refers to the average number of chloromethyl groups per polysulfone repeat unit, as determined by ¹H NMR (FIGS. 14 and 15). Semi-interpenetrating network films were synthesized by swelling 100 μm thick strips of DS 1.8 CMPSf in solutions having styrene monomer and divinylbenzene crosslinker and 2-hydroxy-2-methylpropiophenone (HMPP) photoinitiator for 24 hours (TABLE 1). The total volume of these components was scaled to synthesize larger membranes for MEA fabrication and mechanical testing. The solution containers were wrapped with aluminum foil and placed in a dark location to prevent unwanted photoinitiation. The swollen films were then subjected to UV irradiation (365 nm) for 18 minutes to photoinitiate and polymerize the styrene and/or DVB monomers within the CMPSf membrane. The resulting films were then rinsed thoroughly with water and placed in a 4.6M solution of trimethylamine in ethanol for 24 hours to quaternize the chloromethyl moieties on the linear CMPSf chains.

### Thermogravimetric Analysis

Thermogravimetric Analysis (TGA) measurements were performed with a Mettler Toledo TGA/sDTA 851e. Samples were dried in a vacuum desiccator for 48 hours prior to TGA testing. For TGA of the polymerized monomer solutions, the solutions were thermally polymerized in an oven at 80° C. to give a solid sample.

In a typical test, samples of roughly 3 mg (exact mass measured using the TGA instrument) were loaded into aluminum crucibles and heated from 25° C. to 600° C., under nitrogen, at a rate of 10° C. per minute. Differential TGA (dTGA) plots were generated numerically from the raw data.

### Ion Exchange Capacity

The theoretical IEC was calculated with the following equation:

$$IEC = \frac{1000 * {DS}_{Cl}}{M {W}_{Monomer}} \qquad ( 4 )$$

where DS_{Cl} is the average number of CH₂Cl groups per polysulfone monomer (as determined by ¹H NMR), and MW_{Monomer} is the average molecular weight of a polysulfone repeat unit. This molecular weight was normalized against the mass content of styrene and divinylbenzene in the semi-interpenetrating networks.

Water Uptake and Dimensional Swelling Temperature-dependent gravimetric water uptake (WU) measurements were performed as follows. Membrane samples (hydroxide form) were immersed in water baths (18.2 MΩ·cm at room temperature) at set temperatures ranging from 20° C. to 80° C. After 45 minutes of immersion, the hydrated samples were removed from the water bath and quickly dabbed with a KimWipe to remove surface water. The hydrated mass was then measured gravimetrically using a mass balance. The dimensions of the hydrated samples were then measured and recorded. The dry mass and dimensions of the membranes were determined after drying the samples in a vacuum desiccator for 24 hours. The water uptake was calculated by:

$$WU ( \% ) = 100 * \frac{{m}_{wet} - {m}_{dry}}{{m}_{dry}} \qquad ( 6 )$$

For water uptake kinetics, dry membrane samples in the hydroxide form were swollen in water for set time intervals, after which the hydrated samples were removed, quickly dabbed with a KimWipe to remove surface water, and weighed. The gravimetric water uptake was then calculated by Equation 6 and plotted against time.

### Mechanical Testing

Mechanical properties were measured using an Instron 5844 system with tensile load clamps at a crosshead speed of 1 mm min⁻¹. All membranes were exchanged to the hydroxide form prior to mechanical testing. For “dry” testing, hydrated rectangular membrane samples measuring 3 mm×5 mm were allowed to equilibrate with the ambient environment (20° C., 36-38% RH) for 48 hours.

Tensile testing was then performed under ambient conditions. For characterizing the fully-hydrated membranes, membranes were swollen in nitrogen-purged water for 10 minutes and then cut into 3 mm×5 mm strips. Tensile testing was performed with the samples submersed in liquid water (20° C.) using a BioPuls bath attachment. The elastic modulus was determined from the initial slope of the stress-strain curve according to the ASTM D882 protocol. The average modulus, strength, and elongation-at-break and standard deviations thereof were determined from testing five different samples at each composition.

### Leaching and Alkaline Stability

Leaching stability was determined by monitoring changes in mass and conductivity of five QA sIPN-70/30 membrane samples after immersion in 18.2 MΩ·cm water for 20 days at 40° C. Because of the propensity for hydroxide ions to react with atmospheric carbon dioxide and form carbonates and bicarbonates, all samples were kept in the chloride form for leaching characterization.

For evaluation of alkaline stability, membranes in the hydroxide form were soaked in 6M KOH solution at 40° C. The samples were removed at various time intervals, washed thoroughly with 18.2 MΩ·cm water to rinse off excess hydroxide, and characterized with respect to the in-plane ionic conductivity at room temperature and 100% RH. The gravimetric mass was determined after drying in a vacuum desiccator for 24 hours.

### Conductivity Measurements

A BekkTech BT-552 Conductivity Test System was used to measure the in-plane ionic conductivity. Typical tests were performed as follows. First, a 5-mm wide section of polymer film of known thickness (measured using a Mitutoyo 547-400S digital thickness gauge) was loaded into a BekkTech BT-112 conductivity cell. This cell was then transferred into a Fuel Cell Technologies 5 cm² testing fixture and subjected to a stream of water-saturated nitrogen gas to inhibit carbonate formation. A Keithley 2400 sourcemeter was used to apply a cyclic DC sweep between −0.15 V and +0.15 V, and membrane resistance was determined from the slope of the voltage-current curves. The in-plane conductivity, σ, was calculated from the measured resistance, R, given film thickness, T, film width, W, and inter-electrode distance, L, through the following relation:

$$σ = \frac{L}{R \cdot T \cdot W} \qquad ( 7 )$$

The temperature dependence of the conductivity was determined by ramping up the temperature to specified setpoints between 25° C. and 80° C. Each setpoint was held for 60 minutes to allow for equilibration. In order to maintain 100% RH, the water saturator temperatures were set equal to the temperature of the test cell.

### MEA Fabrication and Testing

Membrane electrode assemblies, having two platinum-coated electrodes sandwiching an alkaline exchange membrane, were fabricated. Catalyst ink was prepared by sonicating for 10 minutes a mixture comprising 52 μL Fumion FAA-3 ionomer solution, 816 μL aqueous isopropanol (60% v/v), and 22 mg Pt/C (TKK TEC10E50E). The ink was then painted onto two 2.5 cm×2.5 cm squares of Sigracet GDL35 BC carbon paper, each to a Pt loading of 0.5 mg cm⁻², to make the cathode and anode materials. The hydroxide-exchanged polyelectrolyte membrane to be tested was then sandwiched between the electrodes in a 5 cm² fuel cell test fixture made by Fuel Cell Technologies to make the MEA. 250 μm thick Teflon gaskets were used to prevent puncturing by the flow channels on compression of the MEA within the testing fixture.

A BekkTech BT-552 test system was used to characterize MEA performance under operation as a hydrogen fuel cell. The MEA was characterized immediately after fabrication and was not subjected to a pre-treatment or activation protocol.

The relative humidity was kept at 100% by flowing water-saturated H₂ (150 SCCM) at the anode and O₂ (200 SCCM) at the cathode. Back pressure was set to 200 kPa absolute. The polarization curve was generated by applying a load between 1.00 V and 0.200 V in 0.05 V increments using an Agilent 6060B load box.

¹H NMR Characterization

A Varian Mercury 400 MHz FT-NMR was used for all ¹H NMR measurements, with deuterated chloroform as solvent. For quantification, values of the integrals were normalized against either the bisphenol A methyl hydrogens (labelled d in FIG. 14) or the β-hydrogens (labelled a in FIG. 14) of the sulfone group. The hydrogens associated with the chloromethyl group show a peak around 4.52 ppm (labelled b in FIG. 14); the normalized integral of this value was used to determine the degree of substitution (DS).

### Bicarbonate and Chloride Conductivity

Bicarbonate and chloride conductivities measured at 20° C. and 100% RH (water-saturated nitrogen gas) are presented in TABLE 7. Note that the QA PSf-226 has greater conductivity than the semi-IPN membranes when in the chloride form, in contrast to the trend in the hydroxide and bicarbonate forms. This is likely due to the much lower water uptake exhibited by membranes with the chloride counterion, mitigating issues resulting from charge dilution and dimensional stability.

TABLE 7
AEM Conductivity at 20° C. and 100% RH.

| Sample | HCO₃⁻ (mS/cm) | Cl⁻ (mS/cm) |
|---|---|---|
| QA PSf-226 | 10.6 | 13.3 |
| QA sIPN-100/0 | 10.3 | 11.1 |
| QA sIPN-95/5 | 11.2 | 10.5 |
| QA sIPN-80/20 | 11.4 | 10.2 |
| QA sIPN-70/30 | 12.1 | 10.3 |

### Small Angle X-ray Scattering

SAXS measurements were performed on beam line 1-4 the Stanford Synchrotron Radiation Lightsource. Radial averaging of the data was performed using the Irena software package for Igor.

The lack of a distinct scattering feature measured suggests that there is no well-defined heterogeneity or structure on the length-scales probed in the experiment; or, if there are well-defined heterogeneities, there is insufficient electron density contrast to observe a scattering signal. This is consistent with previous SAXS investigations of quaternary ammonium-based polysulfones and suggests that the semi-IPN architecture does not significantly influence polymer structure at this length scale. An upturn at lower scattering vector q suggests disperse, large length-scale heterogeneity resulting from the polymer matrix.

### LITERATURE

J. W. Desmond Ng, Y. Gorlin, T. Hatsukade, T. F. Jaramillo, Adv. Energy Mater. 2013, 3, 1545.
S. Lu, J. Pan, A. Huang, L. Zhuang, J. Lu, Proc. Natl. Acad. Sci. 2008, 105, 20611.
G. Merle, M. Wessling, K. Nijmeijer, J. Memb. Sci. 2011, 377, 1.
S. S. Gu, R. Cai, T. Luo, Z. Chen, M. Sun, Y. Liu, G. He, Y. Yan, Angew. Chem. Int. Ed. Engl. 2009, 48, 6499.
S. Gu, R. Cai, T. Luo, K. Jensen, C. Contreras, Y. Yan, ChemSusChem 2010, 3, 555.
N. Li, Y. Leng, M. A. Hickner, C.-Y. Wang, J. Am. Chem. Soc. 2013, 135, 10124.
N. Li, T. Yan, Z. Li, T. Thurn-Albrecht, W. H. Binder, Energy Environ. Sci. 2012, 5, 7888.
J. Pan, C. Chen, Y. Li, L. Wang, L. Tan, G. Li, X. Tang, L. Xiao, J. Lu, L. Zhuang, Energy Environ. Sci. 2014, 7, 354.
S. S. He, C. W. Frank, J. Mater. Chem. A 2014, 2, 16489.
N. Agmon, Chem. Phys. Lett. 2000, 319, 247.
M. R. Hibbs, M. A. Hickner, T. M. Alam, S. K. McIntyre, C. H. Fujimoto, C. J. Cornelius, Chem. Mater. 2008, 20, 2566.
M. A. Hickner, A. M. Herring, E. B. Coughlin, J. Polym. Sci. Part B Polym. Phys. 2013, 51, 1727.
J. R. Varcoe, P. Atanassov, D. R. Dekel, A. M. Herring, M. A. Hickner, P. A. Kohl, A. R. Kucernak, W. E. Mustain, K. Nijmeijer, K. Scott, T. Xu, L. Zhuang, Energy Environ. Sci. 2014, 7, 3135.
J. R. Varcoe, R. C. T. Slade, Fuel Cells 2005, 5, 187.
P. P. Kundu, B. T. Kim, J. E. Ahn, H. S. Han, Y. G. Shul, J. Power Sources 2007, 171, 86.
K.-Y. Cho, H.-Y. Jung, S.-S. Shin, N.-S. Choi, S.-J. Sung, J.-K. Park, J.-H. Choi, K.-W. Park, Y.-E. Sung, Electrochim. Acta 2004, 50, 588.
T. Li, G. Zhong, R. Fu, Y. Yang, J. Memb. Sci. 2010, 354, 189.
Y.-J. Choi, M.-S. Kang, S.-H. Moon, J. Appl. Polym. Sci. 2003, 88, 1488.
L. Chikh, V. Delhorbe, O. Fichet, J. Memb. Sci. 2011, 368,1.
J. Wang, R. He, Q. Che, J. Colloid Interface Sci. 2011, 361, 219.
J. Wang, Z. Zhao, F. Gong, S. Li, S. Zhang, Macromolecules 2009, 42, 8711.
C. G. Arges, M.-S. Jung, G. Johnson, J. Parrondo, V. Ramani, in ECS Trans., 2011, pp. 1795-1816.
C. G. Arges, J. Parrondo, G. Johnson, A. Nadhan, V. Ramani, J. Mater. Chem. 2012, 22, 3733.
J. Pan, S. Lu, Y. Li, A. Huang, L. Zhuang, J. Lu, Adv. Funct. Mater. 2010, 20, 312.
C. Iojoiu, J.-Y. J.-Y. Sanchez, High Perform. Polym. 2009, 21, 673.
J. Zhou, M. Unlu, J. A. Vega, P. A. Kohl, J. Power Sources 2009, 190, 285.
H. Nakagawa, S. Tsuge, Macromolecules 1985, 18, 2068.
J. Pan, S. Lu, Y. Li, A. Huang, L. Zhuang, J. Lu, Adv. Funct. Mater. 2010, 20, 312.
C. Wohlfarth, in Data Extr. from Landoll-Börnstein VIII/6D2 Polym. Polym. Solut. Phys. Prop. Their Relations I (Thermodynamic Prop. PVT-Data Misc. Prop. Polym. Solut. (Eds.: M. D. Lechner, K. F. Arndt), Springer-Verlag Berlin Heidelberg, 2010.
F. Bai, X. Yang, W. Huang, Macromolecules 2004, 37, 9746.
Y. Miwa, O. Urakawa, A. Doi, K. Yamamoto, S. Nobukawa, J. Phys. Chem. B 2012, 116, 1282.
N. Bach Van, C. Noel, J. Polym. Sci. Polym. Chem. Ed. 1976, 14, 1627.
H. Schott, J. Macromol. Sci. Part B 1992, 31, 1.
M. Park, F. E. Turley, R. J. Wycisk, P. N. Pintauro, Macromolecules 2014, 47, 227.
Fujimoto, D.-S. Kim, M. Hibbs, D. Wrobleski, Y. S. Kim, J. Memb. Sci. 2012, 423-424, 438.
DuPont Nafion PFSA Membranes (Data Sheet), 2009.
E. C. Muniz, G. Geuskens, Macromolecules 2001, 34, 4480.
W.-F. Lee, Y.-J. Chen, J. Appl. Polym. Sci. 2001, 82, 2487.
M. Park, P. N. Pintauro, Electrochem. Solid-State Lett. 2012, 15, B27.
M. E. Tuckerman, D. Marx, M. Parrinello, Nature 2002, 417, 925.
G. Arges, V. Ramani, Proc. Natl. Acad. Sci. U.S.A 2013, 110, 2490.
Yuesheng Ye, Yossef A. Elabd, Polymers for Energy Storage and Delivery: Polyelectrolytes for Batteries and Fuel Cells, American Chemical Society, Washington, D C, 2012.
M. R. Sturgeon, C. S. Macomber, C. Engtrakul, B. S. Pivovar, ECS Trans. 2014, 64, 1201.
S. A. Nuñez, M. A. Hickner, ACS Macro Lett. 2013, 2, 49.
M. Zhiani, S. Majidi, M. M. Taghiabadi, Fuel Cells 2013, 13, 946.
J. Ilaysky, P. R. Jemian, J. Appl. Crystallogr. 2009, 42, 347.
J. Yan, M. A. Hickner, Macromolecules 2010, 43, 2349.

What is claimed is:

1. An anion transport membrane, comprising: a linear polymer electrolyte with anion-exchange groups mechanically reinforced by a covalently cross-linked network, wherein the linear polymer electrolyte is partially or fully miscible with the covalently cross-linked network.

2. The membrane as set forth in claim 1, wherein the linear polymer electrolyte is an aromatic polymer

3. The membrane as set forth in claim 2, wherein the aromatic polymer is an poly(phenylene oxide), a polyaryletherketone, a polybenzimidazole or an aromatic polysulfone.

4. The membrane as set forth in claim 1, wherein the anion-exchange group is ammonium, phosphonium, imidazolium, sulfonium, ruthenium, or guanidinium.

5. An anion transport membrane, comprising: a linear quaternary ammonium polysulfone membrane backbone mechanically reinforced by a chemically-crosslinked network of poly(styrene-co-divinylbenzene), wherein the reinforcing network contains covalent divinylbenzene cross-links.

6. The membrane as set forth in claim 5, wherein the linear quaternary ammonium polysulfone membrane backbone is a benzyltrimethylammonium polysulfone membrane backbone.
